(19) United States
(12) Patent Application Publication
(10) Pub. No.: US 2019/0311338 A1
(43) Pub. Date: Oct. 10, 2019

(54) DATA PUSHING METHOD AND APPARATUS, STORAGE MEDIUM, AND ELECTRONIC APPARATUS

(71) Applicant: Tencent Technology (Shenzhen) Company Limited, Shenzhen (CN)

(72) Inventors: Yue LI, Shenzhen (CN); Zhenliang ZHU, Shenzhen (CN); Yun DENG, Shenzhen (CN); Pengfei XIONG, Shenzhen (CN); Dongdong LIU, Shenzhen (CN); Chuntao XIAO, Shenzhen (CN)

(21) Appl. No.: 16/450,468

(22) Filed: Jun. 24, 2019

Related U.S. Application Data
(63) Continuation of application No. PCT/CN2018/080463, filed on Mar. 26, 2018.

(30) Foreign Application Priority Data
Mar. 27, 2017 (CN) 201710190114.0

(51) Int. Cl. G06Q 20/08; H04L 29/08; H04L 12/58; G06T 13/80; G06Q 50/00

(52) U.S. Cl. CPC G06Q 20/0855; H04L 67/26; G06Q 50/01; G06T 13/80; H04L 51/32

(57) ABSTRACT

Embodiments of the present application disclose a data pushing method performed at a server. The server obtains a plurality of pieces of theme data that is to be selected when target push data is pushed, the theme data being used for displaying different theme pages of the target push data; selects, from the theme data, target theme data that is used when the target push data is pushed; and pushes the target push data to a second client and causes displaying, on a first client, a first target theme page that is obtained after the target push data is pushed when a first instruction of the first client is received to push the target push data to the second client, and causes displaying a second target theme page corresponding to the first target theme page on the second client after the second client receives the target push data.

### CROSS-REFERENCE TO RELATED APPLICATIONS

This application is a continuation application of PCT/CN2018/080463, entitled “DATA PUSHING METHOD AND APPARATUS, STORAGE MEDIUM, AND ELECTRONIC APPARATUS” filed on Mar. 26, 2018, which claims priority to Chinese Patent Application No. 201710190114.0, entitled “DATA PUSHING METHOD AND APPARATUS” filed with the Chinese Patent Office on Mar. 27, 2017, all of which are incorporated by reference in their entirety.

### FIELD OF THE TECHNOLOGY

Embodiments of the present application relate to the field of data processing, and specifically, to a data pushing method and apparatus, a storage medium, and an electronic apparatus.

### BACKGROUND OF THE DISCLOSURE

Currently, data pushing may be performed through a network platform having a third-party network payment function. However, this conventional data pushing manner is too undiversified to satisfy various service backgrounds. For example, an online payment function is promoted through digital red packets popular on platforms such as an instant messaging application. The digital red packets have very strong lunar festival attributes, and audiences thereof are mainly ethnic Chinese. Currently, conventional red packets are generally popular inside and outside China. No company and institution provide digital red packets that satisfy diversified cultures to the Malay. Therefore, the digital red packets have an undiversified pushing manner.

In some cases, data pushing needs to satisfy diversified demands. For example, in overseas countries such as Malaysia, there is also a tradition, similar to that of ethnic Chinese, of dispatching paper red packets to relatives and friends at local festivals such as Hari Raya, Deepavali, and Lunar New Year. Packet colors and background patterns of the paper red packets are different because of religious cultures of native ethnic groups, while current data pushing cannot well satisfy a demand in a service background of co-existence of a plurality of ethnic groups and a plurality of religions.

For the foregoing problem that diversified demands of data pushing cannot be satisfied when data is pushed, currently, no effective solution is proposed.

### SUMMARY

The embodiments of the present application provide a data pushing method and apparatus, a storage medium, and an electronic apparatus, to resolve at least a problem in a related technology that diversified demands of data pushing cannot be satisfied when data is pushed.

According to an aspect of the embodiments of the present application, a data pushing method is performed at a server having one or more processors and memory storing a plurality of operations to be executed by the one or more processors, the method comprising: obtaining a plurality of pieces of theme data that is to be selected when target push data is pushed via a social networking application, the plurality of pieces of theme data being used for displaying different theme pages of the target push data; selecting, from the plurality of pieces of theme data, target theme data that is used when the target push data is pushed; and pushing the target push data to a second client and causing displaying, on a first client, a first target theme page that is obtained after the target push data is pushed when a first instruction of the first client is received, and causing displaying a second target theme page corresponding to the first target theme page on the second client after the second client receives the target push data, the first instruction being used for instructing to push the target push data to the second client, the first client logging in to a first account of the social networking application, and the second client logging in to a second account of the social networking application.

According to another aspect of the embodiments of the present application, a server has one or more processors and one or more memories storing program modules. The program modules, when executed by the one or more processors, cause the server to perform the aforementioned data pushing method.

According to another aspect of the embodiments of the present application, a non-transitory computer readable storage medium stores a plurality of machine readable instructions in connection with a server having one or more processors. The plurality of machine readable instructions, when executed by the one or more processors, cause the server to perform the aforementioned data pushing method.

In the embodiments of the present application, a plurality of pieces of theme data that is to be selected when target push data is pushed is obtained, the plurality of pieces of theme data being used for displaying different theme pages of the target push data; target theme data that is used when the target push data is pushed is selected from the plurality of pieces of theme data; and the target push data is pushed to a second client and a first target theme page that is obtained after the target push data is pushed is displayed on a first client when a first instruction of the first client is received, and a second target theme page corresponding to the first target theme page is displayed on the second client after the second client receives the target push data, the first instruction being used for instructing to push the target push data to the second client, the first client logging in to a first account, and the second client logging in to a second account. The theme data of the plurality of theme pages is provided, the target theme data is determined in the plurality of pieces of theme data, the target push data is pushed in a form of the first target theme page according to the target theme data, and the second target theme page corresponding to the first target theme page is displayed on the second client, to push data, to achieve a technical effect of satisfying diversified demands of data pushing when data is pushed, to resolve the technical problem in the related technology that diversified demands of data pushing cannot be satisfied when data is pushed.

### BRIEF DESCRIPTION OF THE DRAWINGS

Accompanying drawings described herein are used for providing further understanding about the embodiments of the present application, and constitute one portion of the present disclosure; and schematic embodiments of the present application and their description are used for explaining the present disclosure, and do not constitute an inappropriate limit on the present disclosure. In the figures:

FIG. 1 is a schematic diagram of a hardware environment of a data pushing method according to an embodiment of the present application.

FIG. 2 is a flowchart of a data pushing method according to an embodiment of the present application.

FIG. 3 is a flowchart of a method for obtaining a plurality of pieces of theme data that is to be selected when target push data is pushed according to an embodiment of the present application.

FIG. 4 is a flowchart of a method for selecting, from a plurality of pieces of theme data, target theme data that is used when target push data is pushed according to an embodiment of the present application.

FIG. 5 is a flowchart of another data pushing method according to an embodiment of the present application.

FIG. 6 is a flowchart of another data pushing method according to an embodiment of the present application.

FIG. 7 is an interactive flowchart of a method for pushing a digital red packet according to an embodiment of the present application.

FIG. 8 is a schematic diagram of a page with a default theme according to an embodiment of the present application.

FIG. 9 is a schematic diagram of a page selecting a red packet category according to an embodiment of the present application.

FIG. 10A is a schematic diagram of a page for a client to receive a red packet according to an embodiment of the present application.

FIG. 10B is a schematic diagram of another page for a client to receive a red packet according to an embodiment of the present application.

FIG. 10C is a schematic diagram of another page for a client to receive a red packet according to an embodiment of the present application.

FIG. 11A is a schematic diagram of a page for a client to open a red packet according to an embodiment of the present application.

FIG. 11B is a schematic diagram of another page for a client to open a red packet according to an embodiment of the present application.

FIG. 11C is a schematic diagram of another page for a client to open a red packet according to an embodiment of the present application.

FIG. 12 is a schematic diagram of a data pushing apparatus according to an embodiment of the present application.

FIG. 13 is a schematic diagram of another data pushing apparatus according to an embodiment of the present application.

FIG. 14 is a schematic diagram of another data pushing apparatus according to an embodiment of the present application.

FIG. 15 is a schematic diagram of another data pushing apparatus according to an embodiment of the present application.

FIG. 16 is a schematic diagram of another data pushing apparatus according to an embodiment of the present application.

FIG. 17 is a structural block diagram of an electronic apparatus according to an embodiment of the present application.

### DESCRIPTION OF EMBODIMENTS

To make a person skilled in the art understand the solutions in the present disclosure better, the following clearly and completely describes the technical solutions in the embodiments of the present application with reference to the accompanying drawings in the embodiments of the present application. Apparently, the described embodiments are merely some but not all of the embodiments of the present application. All other embodiments obtained by a person of ordinary skill in the art based on the embodiments of the present application without creative efforts shall fall within the protection scope of the present disclosure.

It should be noted that, the specification and claims of the present disclosure, and terms “first” and “second” in the foregoing accompanying drawings are used for distinguishing similar objects, but are unnecessarily used for describing a specific sequence or order. It should be understood that, data used in this way is exchangeable in a proper case, so that the embodiments of the present application that are described herein can be implemented in another order except those shown or described herein. Moreover, the terms “include”, “contain” and any other variants mean to cover the non-exclusive inclusion. For example, a process, method, system, product, or device that includes a series of steps or units is not necessarily limited to those steps or units that are expressly listed, but may include other steps or units not expressly listed or inherent to such a process, method, product, or device.

According to an aspect of the embodiments of the present application, an embodiment of a data pushing method is provided.

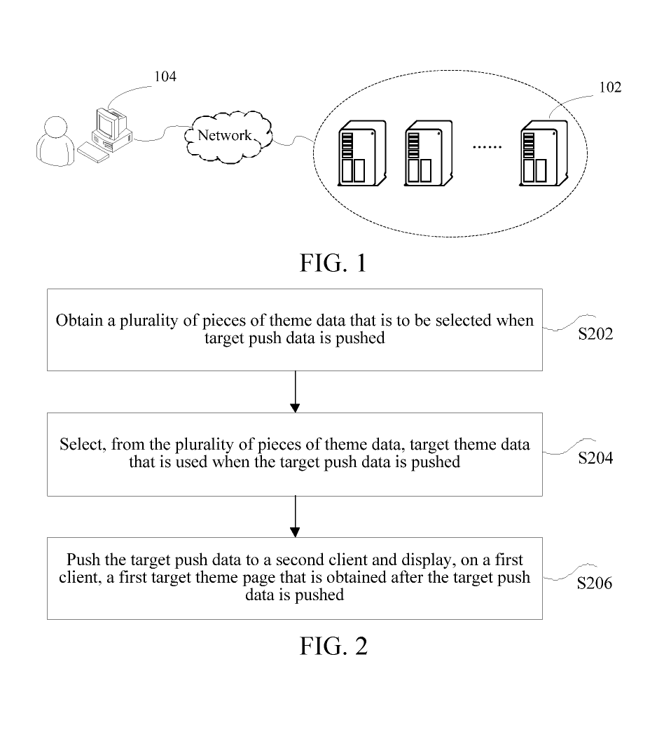

Optionally, in this embodiment, the data pushing method may be applied to a hardware environment including a server 102 and a terminal 104 in FIG. 1. FIG. 1 is a schematic diagram of a hardware environment of a data pushing method according to an embodiment of the present application. As shown in FIG. 1, the server 102 is connected to the terminal 104 through a network. The network includes but is not limited to: a wide area network, a metropolitan area network, or a local area network, and the terminal 104 is not limited to a PC, a mobile phone, a tablet computer, or the like. The data pushing method in this embodiment of the present application may be performed by the server 102, or may be performed by the terminal 104, or may be performed by both the server 102 and the terminal 104. When the terminal 104 performs the data pushing method in this embodiment of the present application, the data pushing method may alternatively be performed by a client installed in the terminal 104.

FIG. 2 is a flowchart of a data pushing method according to an embodiment of the present application. As shown in FIG. 2, the data pushing method may include the following steps:

Step S202: Obtain a plurality of pieces of theme data that is to be selected when target push data is pushed.

In the technical solution provided in step S202 of this application, the plurality of pieces of theme data is used for displaying different theme pages of the target push data.

The obtained plurality of pieces of theme data that is to be selected when the target push data is pushed may be a plurality of pieces of theme data that is preloaded on a client. Different theme data may have different religious features and correspond to different festivals and receiving objects of the target push data. The target push data is data pushed by a plurality of accounts through the client and may be digital red packet data. For example, a user may send, to an account corresponding to another user through a network platform having a third-party payment capability such as an instant messaging application, a digital red packet that has consumption utility and whose appearance is similar to that of a conventional paper red packet.

A theme of the target push data is used for indicating an actual meaning of the target push data. The meaning may be a religious feature, a particular festival blessing, or the like. Theme data of the target push data is used for displaying the theme pages of the target push data, that is, data related to a theme pushed by the target push data, including data for selecting a theme, data of the theme itself, and the like. Different themes may be distinguished through different colors, different textures, and the like. In addition, the theme data may further include default text information corresponding to the theme.

Optionally, when the target push data is the digital red packet data, the theme data is data related to a packet of the digital red packet, including data for selecting the packet, data of the packet itself, and the like, and further including color data, texture data, and the like of the packet. The packet is a package envelope in which money is wrapped and that is used as a red packet to be given to a person. For example, a Duit Raya is a green packet on which the Malayan write blessings with colorful papers of different colors having certain implied meanings and that is given to relatives and friends to express love. At the Hari Raya of the Malay, the elderly puts money in little green envelopes or wraps money with green papers, and distributes them one by one when children enters the door. Patterns of green packets are mainly mosques, the Koran, and ethnic customs and patterns. An ethnic Chinese red packet is a blessing red packet that is related to the Chinese New Year and that is sent in festivals such as the Lunar New Year. At the Deepavali, a Deepavali Purple Packet is a purple packet that is sent by local Indians to relatives and friends and that contains money. Patterns of the purple packets are mostly Gods and Buddhas, peacocks, magic lamps, dances, and the like.

Step S204: Select, from the plurality of pieces of theme data, target theme data that is used when the target push data is pushed.

In the technical solution provided in step S204 of this application, the target theme data is theme data that is selected from the plurality of pieces of theme data and that is used when the target push data is pushed, and that the target push data has a meaning is indicated through the theme data. For example, the target theme data is theme data of a Duit Raya and is used for indicating the Hari Raya of the Malay. The target theme data is theme data of an ethnic Chinese red packet and is used for indicating the Lunar New Year. The target theme data is theme data of a Deepavali Purple Packet and is used for indicating the Deepavali of India.

Optionally, after the plurality of pieces of theme data that is to be selected when the target push data is pushed is obtained, an identifier of the plurality of pieces of theme data is displayed on a page of a client. The identifier may be a color identifier, such as a green identifier of a Duit Raya, a red identifier of an ethnic Chinese red packet, and a purple identifier of a Deepavali Purple Packet. The identifier may alternatively be a text identifier, such as text identifiers of a Duit Raya, an ethnic Chinese red packet, and a Deepavali Purple Packet.

Optionally, the plurality of pieces of theme data may be exhibited in a form of a pull-down list. The pull-down list includes theme identifiers respectively corresponding to the plurality of pieces of theme data, and a theme identifier corresponding to the target theme data is selected from the pull-down list.

An identifier of identifiers of the plurality of pieces of theme data is used to receive an instruction for selecting target theme data corresponding to the identifier, to select, from the plurality of pieces of theme data, the target theme data that is used when the target push data is pushed, thereby improving user experience.

Step S206: Push the target push data to a second client and display, on a first client, a first target theme page that is obtained after the target push data is pushed.

In the technical solution provided in step S206 of this application, the target push data is pushed to a second client and a first target theme page that is obtained after the target push data is pushed is displayed on a first client when a first instruction of the first client is received, and a second target theme page corresponding to the first target theme page is displayed on the second client after the second client receives the target push data, the first instruction being used for instructing to push the target push data to the second client, the first client logging in to a first account, and the second client logging in to a second account.

After the target theme data that is used when the target push data is pushed is selected from the plurality of pieces of theme data, the first client logs in to the first account, and the first instruction is received. The first instruction is used for instructing to push the target push data to the second client. The first instruction may be generated by a user to perform a touch operation in a preset area of a page displayed by the client. When the first instruction is received, the target push data is pushed to the second client, and the first target theme page that is obtained after the target push data is pushed is displayed on the first client. The first target theme page is a page corresponding to the target theme data, including a message of the target push data. Optionally, when the target theme data is theme data of a Duit Raya, the first target theme page is a theme page of the Duit Raya that is obtained after the target push data is pushed. When the target theme data is theme data of an ethnic Chinese red packet, the first target theme page is a theme page of the ethnic Chinese red packet that is obtained after the target push data is pushed. When the target theme data is theme data of a Deepavali Purple Packet, the first target theme page is a theme page of the Deepavali Purple Packet that is obtained after the target push data is pushed.

After the target push data is pushed to the second client, the second client receives the target push data, and the second target theme page corresponding to the first target theme page is displayed on the second client. The second target theme page and the first theme page are pages of the same theme. The color and/texture of the second theme page may be the same as or be similar to that of the first target theme page, and the second theme page is used for indicating that the second client already receives the target push data pushed by the first client and may be a red packet message. The second client logs in to the second account, and the second account and the first account may be friend accounts of one another, to well satisfy demands of data pushing in different service backgrounds, thereby improving diversified demands of data pushing.

Optionally, the second client receives an instruction for instructing to display the target push data through the second theme page and displays a theme, text information, and the like corresponding to the target theme data, thereby improving diversified demands of data pushing.

In the foregoing steps S202 to step S206, a plurality of pieces of theme data that is to be selected when target push data is pushed is obtained, the plurality of pieces of theme data being used for displaying different theme pages of the target push data; target theme data that is used when the target push data is pushed is selected from the plurality of pieces of theme data; and the target push data is pushed to a second client and a first target theme page that is obtained after the target push data is pushed is displayed on a first client when a first instruction of the first client is received, and a second target theme page corresponding to the first target theme page is displayed on the second client after the second client receives the target push data, the first instruction being used for instructing to push the target push data to the second client, the first client logging in to a first account, and the second client logging in to a second account. The theme data of the plurality of theme pages is provided, the target theme data is determined in the plurality of pieces of theme data, the target push data is pushed in a form of the first target theme page according to the target theme data, and the second target theme page corresponding to the first target theme page is displayed on the second client, to push data, to achieve a technical effect of satisfying diversified demands of data pushing when data is pushed, to resolve the technical problem in the related technology that diversified demands of data pushing cannot be satisfied when data is pushed.

In an optional implementation, step S202 of obtaining a plurality of pieces of theme data that is to be selected when target push data is pushed includes: displaying, on the first client, an interactive window used by the first account and the second account to perform a data exchange event; receiving a second instruction through the interactive window; and receiving the plurality of pieces of theme data that is sent by the server according to the second instruction.

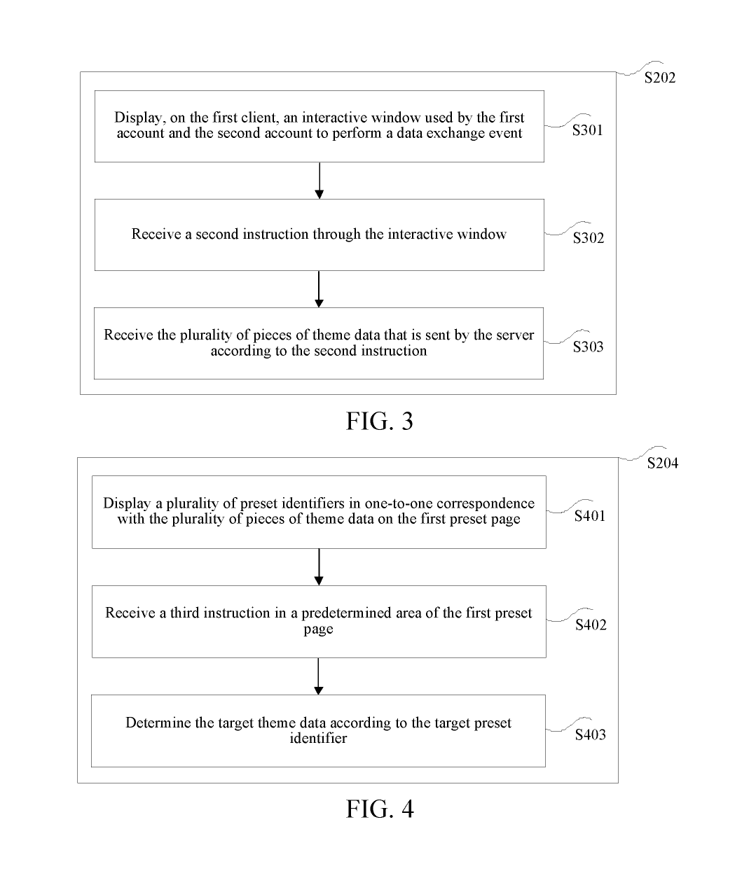

FIG. 3 is a flowchart of a method for obtaining a plurality of pieces of theme data that is to be selected when target push data is pushed according to an embodiment of the present application. As shown in FIG. 3, the method includes the following steps:

Step S301: Display, on the first client, an interactive window used by the first account and the second account to perform a data exchange event.

In the technical solution provided in step S301 of this application, the first account and the second account may be accounts participating in chats, such as chat accounts in an instant messaging application. When the plurality of pieces of theme data that is to be selected when the target push data is pushed is obtained, the interactive window used by the first account and the second account to perform the data exchange event is displayed on the first client. For example, the interactive window is a chat window in which the first account and the second account perform a chat event. Optionally, the second account is an account in a chat group that the first account joins. That is, the second account includes another account other than the first account in the chat group.

Optionally, the interactive window includes an area for displaying a chat message and further includes a functional area and the like for performing an interaction event, and is not limited herein.

Step S302: Receive a second instruction through the interactive window.

In the technical solution provided in step S302 of this application, the second instruction is used for instructing to display a first preset page and requesting, from a server, the plurality of pieces of theme data, and the first preset page is used for prompting the first account to set the target push data.

After the interactive window used by the first account and the second account to perform the data exchange event is displayed, the second instruction is received through the interactive window. The second instruction is used for instructing to display the first preset page. The first preset page is used for prompting the first account to set the target push data. After the second instruction is received, the first preset page is displayed on the first client, the first account may be prompted through the first preset page to set the target push data. For example, the first preset page is a red packet sending page and is used for setting the number of digital red packets, the amounts of the digital red packets, remark information of the digital red packets, and the like. The remark information may be blessings, message information, and the like and is not limited herein.

Step S303: Receive the plurality of pieces of theme data that is sent by the server according to the second instruction.

In the technical solution provided in step S303 of this application, while the second instruction is received through the interactive window to display the first preset page, the plurality of pieces of theme data requests, from the server through the second instruction, to be obtained, the server stores the plurality of pieces of theme data related to a theme of the target push data and may store identifiers ID, color data and texture data of the theme, default text information corresponding to the theme, and the like. For example, the theme data is related data of a multi-cultural packet, and includes data for indicating the color and a texture pattern of the packet and a default blessing corresponding to the theme, and the like. While the first preset page is displayed on the first client, the plurality of pieces of theme data requests, from the server through the first instruction, to be obtained, the server responds to the request and sends the plurality of pieces of theme data to the first client, and the first client receives the plurality of pieces of theme data.

Optionally, when the theme data stored in the server changes, theme data loaded on the client synchronously changes with the theme data stored in the server, to ensure consistency between the theme data stored on the client and that stored on the server.

In this embodiment, an interactive window used by the first account and the second account to perform a data exchange event is displayed on a first client; a second instruction is received through the interactive window, the second instruction being used for instructing to display a first preset page and requesting, from a server, the plurality of pieces of theme data, the first preset page being used for prompting the first account to set the target push data; and the plurality of pieces of theme data that is sent by the server is received according to the second instruction, to obtain the plurality of pieces of theme data that is to be selected when the target push data is pushed. Further, the target push data is pushed to a second client and a first target theme page that is obtained after the target push data is pushed is displayed on the first client when a first instruction of the first client is received, to achieve a technical effect of satisfying diversified demands of data pushing when data is pushed.

In an optional implementation, step S204 of selecting, from the plurality of pieces of theme data, target theme data that is used when the target push data is pushed includes: displaying a plurality of preset identifiers in one-to-one correspondence with the plurality of pieces of theme data on the first preset page; receiving a third instruction in a predetermined area of the first preset page; and determining the target theme data according to the target preset identifier.

FIG. 4 is a flowchart of a method for selecting, from a plurality of pieces of theme data, target theme data that is used when target push data is pushed according to an embodiment of the present application. As shown in FIG. 4, the method includes the following steps:

Step S401: Display a plurality of preset identifiers in one-to-one correspondence with the plurality of pieces of theme data on the first preset page.

In the technical solution provided in step S401 of this application, the first preset page is used for prompting the first account to set the target push data, and first preset page is further used for displaying the plurality of preset identifiers corresponding to the plurality of pieces of theme data. After the plurality of pieces of theme data that is to be selected when the target push data is pushed is obtained, the plurality of preset identifiers in one-to-one correspondence with the plurality of pieces of theme data is displayed on the first preset page. The plurality of preset identifiers may be displayed in a form of a pull-down list and may be a plurality of color identifiers, a plurality of text identifiers, a plurality of texture identifiers, and the like. The plurality of color identifiers may be distinguished through a plurality of different colors, the plurality of text identifiers may be distinguished through a plurality of different default blessings, and the plurality of texture identifiers may be distinguished through a plurality of different textures. The plurality of preset identifiers may have preset shapes, such as a shape similar to a red packet.

For example, a preset identifier of a Duit Raya theme on the first preset page is green, a preset identifier of an ethnic Chinese red packet theme is red, and a preset identifier of a Deepavali Purple Packet theme is purple, so that the Duit Raya theme, the ethnic Chinese red packet theme, and the Deepavali Purple Packet theme are distinguished on the first preset page, facilitating selection of the user and satisfying diversified demands of data pushing.

Step S402: Receive a third instruction in a predetermined area of the first preset page.

In the technical solution provided in step S402 of this application, the third instruction is used for instructing to select the target preset identifier from the plurality of preset identifiers, the target preset identifier corresponding to the target theme data.

After the plurality of preset identifiers in one-to-one correspondence with the plurality of pieces of theme data is displayed on the first preset page, the third instruction is received in the predetermined area of the first preset page, and the predetermined area is an area corresponding to the plurality of preset identifiers. Optionally, the location of the predetermined area is the same as that of the plurality of preset identifiers on the first preset page. The third instruction may be an instruction generated by the user to perform a touch operation in the predetermined area displayed by the first client. When the location of the predetermined area is the same as that of the plurality of preset identifiers on the first preset page, the third instruction may be an instruction generated by the user to perform a touch operation on the preset identifiers displayed by the first client. The third instruction is used for instructing to select the target preset identifier from the plurality of preset identifiers, and the target preset identifier corresponds to the target theme data.

For example, the target preset identifier is any one of a preset identifier of a Duit Raya theme, a preset identifier of an ethnic Chinese red packet theme, a preset identifier of a Deepavali Purple Packet theme, and the like and may be selected according to wills of the user.

Step S403: Determine the target theme data according to the target preset identifier.

In the technical solution provided in step S403 of this application, after the third instruction is received through the predetermined area of the first preset page, the target theme data is determined according to the target preset identifier. For example, when the target preset identifier is a preset identifier of a Duit Raya theme, the target theme data is theme data related to a Duit Raya. When the target preset identifier is a preset identifier of an ethnic Chinese red packet theme, the target theme data is theme data related to an ethnic Chinese red packet. When the target preset identifier is a preset identifier of a Deepavali Purple Packet theme, the target theme data is theme data related to a Deepavali Purple Packet.

Optionally, in a process in which the first client pushes the target push data to the second client, a target theme displayed on the first client changes as the target preset identifier varies.

In this embodiment, a plurality of preset identifiers in one-to-one correspondence with the plurality of pieces of theme data is displayed on the first preset page, a third instruction is received in a predetermined area of the first preset page, the third instruction being used for instructing to select a target preset identifier from the plurality of preset identifiers, the target preset identifier corresponding to the target theme data; and the target theme data is determined according to the target preset identifier, to select, from the plurality of pieces of theme data, the target theme data that is used when the target push data is pushed.

In an optional implementation, the first preset page is displayed as a page with a default theme after the second instruction is received through the interactive window and before the target theme data that is used when the target push data is pushed is selected from the plurality of pieces of theme data.

The first client may display the page with the default theme. Optionally, information, such as the color and the text, about the page of the default theme is predetermined. The first preset page is displayed as the page with the default theme after the second instruction is received through the interactive window and before the target theme data that is used when the target push data is pushed is selected from the plurality of pieces of theme data. Optionally, the target push data is a digital red packet, the plurality of pieces of theme data corresponds to different objects that receive the target push data and festivals at which the target push data is received. When the user uses a digital red packet for the first time, because a purpose for the user to send a red packet and an object that receives the red packet cannot be determined, the page displayed on the first client is set to be orange with no religious feature as a default color.

In an optional implementation, after the target theme data that is used when the target push data is pushed is selected from the plurality of pieces of theme data, the page with the default theme is replaced with a second preset page according to the target theme data, the second preset page matching the target theme data.

The target theme data is data related to a theme of the target push data. After the target theme data that is used when the target push data is pushed is selected from the plurality of pieces of theme data, the page with the default theme is replaced with the second preset page according to the target theme data. That is, the first preset page displayed as the page of the default theme is replaced with the second preset page. The second preset page matches the target theme data.

Optionally, the user may change red packet categories according to festivals and objects to which packets are sent. The red packet categories provided to the user for selection include a Duit Raya, an ethnic Chinese red packet, a Deepavali Purple Packet, and the like. After the user selects different red packets, the color and texture of the red packet displayed on the first client change, to replace the page with the default theme with the second preset page according to the target theme data.

In an optional implementation, the pushing the target push data to a second client includes at least one of: instructing the second client to display the second target theme page having a correspondence with the first target theme page when the target push data is pushed to the second client, the first target theme page including a first color, the second target theme page including a second color, and the first target color corresponding to the second target color; instructing the second client to display the second target theme page having a correspondence with the first target theme page when the target push data is pushed to the second client, the first target theme page including a first texture, the second target theme page including a second texture, and the first texture corresponding to the second texture; and instructing the second client to display the second target theme page having a correspondence with the first target theme page when the target push data is pushed to the second client, the first target theme page including a first animation element, the second target theme page including a second animation element, and the first animation element corresponding to the second animation element.

The first theme page displayed on the first client and the second theme page displayed on the second client have a correspondence. The correspondence may be a correspondence of colors. The first target theme page includes the first color. The second target theme page includes the second color. The first target color and the second target color may be the same or may be similar colors. For example, a first theme page of a Duit Raya is dark green, and a second theme page of the Duit Raya is light green; a first theme page of an ethnic Chinese red packet is dark red, and a second theme page of the ethnic Chinese red packet is light red; a first theme page of a Deepavali Purple Packet is dark purple, and a second theme page of the Deepavali Purple Packet is light purple.

The correspondence between the first theme page and the second theme page may alternatively be a correspondence of textures. The first target theme page includes the first texture. The second target theme page includes the second texture. The first texture and the second texture may be the same or may be similar. For example, textures of Duit Rayas are mainly textures such as mosques, the Koran, and ethnic customs and patterns. Therefore, the texture of the first theme page and the texture of the second theme page of the Duit Raya may be textures such as mosques, the Koran, and ethnic customs and patterns. Textures of Deepavali Purple Packets are mostly textures such as Gods and Buddhas, peacocks, magic lamps, dances. The textures of the first theme page and the second theme page of the Deepavali Purple Packet may be textures such as Gods and Buddhas, peacocks, magic lamps, and dances.

The correspondence between the first theme page and the second theme page may alternatively be a correspondence of animation elements. The first target theme page includes the first animation element. The second target theme page includes the second animation element. The first animation element and the second animation element may be the same or may be similar. The first animation element and the second animation element may be animation elements related to festivals. For example, on a Lunar New Year red packet, an animation element of setting off firecrackers may be added on the first theme page and the second theme page, to increase user reputation and enthusiasm for user propagation, to achieve a technical effect of satisfying diversified demands of data pushing when data is pushed.

It should be noted that colors, textures, animations, and the like of the theme in this embodiment of the present application differ due to the religion and culture of native ethnic groups. However, this embodiment is not limited to the foregoing colors, textures, and animations. Any theme that can satisfy diversified demands of the target push data falls within the protection scope of the present disclosure and is not described by way of example one by one herein again.

In an optional implementation, step S204 of selecting, from the plurality of pieces of theme data, target theme data that is used when the target push data is pushed includes: determining the target theme data corresponding to a preset date in the plurality of pieces of theme data when a current date is the preset date; and/or determining the target theme data corresponding to a preset condition in the plurality of pieces of theme data when the second account meets the preset condition.

The target push data may be push data related to festivals and/or related to the preset object receiving the target push data. The Hari Raya is a festival at which the global Muslims celebrate the end of Ramadan. A Duit Raya is a green packet, where at the Hari Raya of the Malay, the elderly puts money in little green envelopes or wraps money with green papers, and distributes them one by one when children enters the door. Patterns of a Duit Raya are mainly mosques, the Koran, and ethnic customs and patterns. The Deepavali is also translated as Diwali or Deepavali, is a five-day festival held on the 15th Full Moon in August of the Hindu calendar every year. Local Indians send Deepavali Purple Packets that contain money to relatives and friends. Patterns of the Deepavali Purple Packets are mostly Gods and Buddhas, peacocks, magic lamps, dances, and the like. At the Lunar New Year, the sent red packets may be red packets on which animations of setting off firecrackers are added, to corresponding to festival atmospheres, to well satisfy diversified demands of data pushing in different service backgrounds.

The target theme data corresponding to a preset condition is determined in the plurality of pieces of theme data when the second account meets the preset condition. The preset condition may be a condition that is met by a preset object using the second account and may correspond to a user corresponding to the second account. The preset object of the target push data may be an old man, a child, or the like. For example, when a digital red packet is pushed on the birthday of the old man, the target theme data determined in the plurality of pieces of theme data is data related to congratulations about the birthday. The birthday of the old man may be determined in registration information that is obtained when the old man originally registers an account. For another example, when digital red packets are sent to children on the International Children's Day, the target theme data determined in the plurality of pieces of theme data is data related to the International Children's Day, to well satisfy diversified demands of data pushing in different service backgrounds.

In an optional implementation, after the target push data is pushed to the second client, a third theme page corresponding to the second target theme page is displayed and the target push data is displayed on the third theme page when the second client receives a fourth instruction, the fourth instruction being used for instructing the second client to display the third theme page.

The target push data may be a digital red packet. The fourth instruction is used for instructing to open the digital red packet on the second client and may be generated by the user to perform a touch operation on a display interface of the second client. After the second client receives the fourth instruction, after a friend user clicks on a red packet message, the second client displays the third theme page corresponding to the target theme data. The third theme page is used for displaying the target push data and also displaying remark information of the target push data, such as blessings. In addition, the target push data is stored at a preset storage location. For example, red packet cash is automatically transferred to a balance account in a wallet of an instant messaging application of the user.

In an optional implementation, before the target push data is pushed to the second client, a first setting instruction of the first account is received through the first client; and the target push data is obtained according to the first setting instruction.

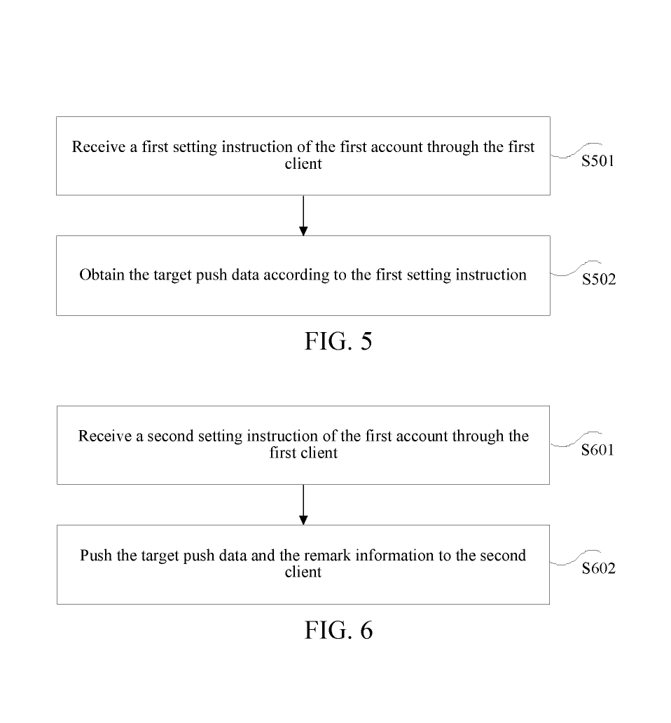

FIG. 5 is a flowchart of another data pushing method according to an embodiment of the present application. As shown in FIG. 5, the method further includes the following steps:

Step S501: Receive a first setting instruction of the first account through the first client.

In the technical solution provided in step S501 of this application, the first setting instruction is used for instructing to set the target push data.

Before the target push data is pushed to the second client, the first setting instruction of the first account is received through the first client. The first setting instruction may be received through the first preset page of the first client. The first setting instruction may be generated by the user to perform a touch operation at a predetermined location on the first preset page and is used for instructing to set the size of the target push data. For example, when the target push data is a digital red packet, the first setting instruction may be used for instructing to set the amount of the digital red packet.

Step S502: Obtain the target push data according to the first setting instruction.

In the technical solution provided in step S502 of this application, after the first setting instruction of the first account is received through the first client, the target push data is obtained according to the first setting instruction. For example, the user inputs an amount 8.80 RMB to the first client, and thus the first client obtains 8.80 RMB. Optionally, when the user does not input an amount to the first client and performs a next operation, prompt information for prompting the user to input the amount is displayed, to ensure that the target push data can be obtained according to the first setting instruction.

In this embodiment, before the target push data is pushed to the second client, a first setting instruction of the first account is received through the first client, the first setting instruction being used for instructing to set the target push data; and the target push data is obtained according to the first setting instruction, to obtain the target push data.

In an optional implementation, before the target push data is pushed to the second client, a second setting instruction of the first account is received through the first client; and the pushing the target push data to a second client includes: pushing the target push data and the remark information to the second client.

FIG. 6 is a flowchart of another data pushing method according to an embodiment of the present application. As shown in FIG. 6, the method further includes the following steps:

Step S601: Receive a second setting instruction of the first account through the first client.

In the technical solution provided in step S601 of this application, the second setting instruction is used for instructing to set remark information of the target push data.

Before the target push data is pushed to the second client, the second setting instruction of the first account is received through the first client. The second setting instruction may be received through the first preset page of the first client. The second setting instruction may be generated by the user to perform a touch operation at a predetermined location on the first preset page and is used for instructing to set the remark information of the target push data. For example, when the target push data is a digital red packet, the second setting instruction may be used for instructing to set blessing information of the digital red packet. Optionally, the user inputs the remark information to the first client. When the user does not input remark information to the first client, the remark information may be default remark information preset by the first client. For example, the default remark information is “Best wishes”.

Optionally, the first setting instruction and the second setting instruction are received through the first client in a non-specific order.

Step S602: Push the target push data and the remark information to the second client.

In the technical solution provided in step S602 of this application, after the second setting instruction of the first account is received through the first client, the second client pushes the target push data and the remark information.

In this embodiment, before the target push data is pushed to the second client, a second setting instruction of the first account is received through the first client, the second setting instruction being used for instructing to set remark information of the target push data; and the pushing the target push data to a second client includes: pushing the target push data and the remark information to the second client, to push the remark information to the second client.

It should be noted that, for ease of description, the foregoing method embodiments are expressed as a series of actions. However, a person skilled in the art should appreciate that the present disclosure is not limited to the described action sequence, because according to the present disclosure, some steps may be performed in other sequences or performed simultaneously. In addition, a person skilled in the art should also understand that the embodiments described in this specification all belong to exemplary embodiments, and the involved actions and modules are not necessarily mandatory to the present disclosure.

Based on the foregoing descriptions of the embodiments, a person skilled in the art may clearly understand that the method in the foregoing embodiments may be implemented by software in addition to a necessary universal hardware platform or by hardware only. However, the former is a better implementation in most cases. Based on such an understanding, the technical solutions of the present disclosure essentially or the part contributing to the prior art may be implemented in a form of a software product. The computer software product is stored in a storage medium (such as a ROM/RAM, a magnetic disk, or an optical disc) and includes several instructions for instructing a terminal device (which may be a mobile phone, a computer, a server, a network device, or the like) to perform the methods described in the embodiments of the present application.

The following describes the technical solutions of the present disclosure with reference to preferred embodiments. Specifically, descriptions are provided by way of example by using the target push data as a digital red packet, using the theme data of the target push data as data related to a packet, and using the client as a client of an instant messaging application.

In a process in which a Malaysian user sends a red packet, the client exhibits a plurality of theme packets, and the user selects one theme packet and distributes the theme packet to a friend in a chat window. In this case, the chat window displays a red packet message whose color and texture pattern are consistent with that of the selected theme packet.

After a client corresponding to the friend user clicks the received red packet message, a corresponding theme packet and blessing are exhibited, and red packet cash is automatically transferred to a balance account of a wallet of the user.

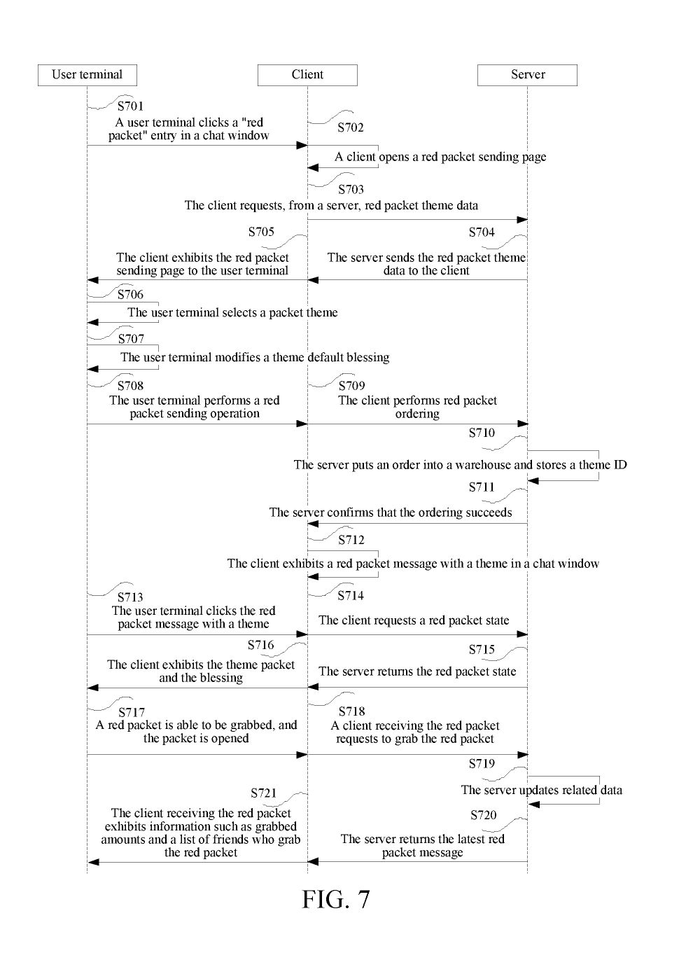

FIG. 7 is an interactive flowchart of a method for pushing a digital red packet according to an embodiment of the present application. As shown in FIG. 7, the method includes the following steps:

Step S701: A user terminal clicks a “red packet” entry in a chat window.

The chat window is used for displaying messages sent between a plurality of accounts on a client and includes a plurality of functions related to a chat event. The user terminal clicks the “red packet” entry in the chat window, and the “red packet” entry is used for enabling the client to enter a functional state of sending a red packet.

Step S702: A client opens a red packet sending page.

After the user terminal clicks the “red packet” entry in the chat window, the client opens the red packet sending page. The red packet sending page is the first preset page in the foregoing embodiment.

Step S703: The client requests, from a server, red packet theme data.

After the user terminal clicks the “red packet” entry in the chat window, the client sends a request to the server, to request the red packet theme data.

Step S704: The server sends the red packet theme data to the client.

The server stores multi-cultural packet related data, including data such as the packet color, a texture and a pattern, and a default blessing corresponding to a theme. After the server requests the red packet theme data, the server responds to the request and sends the red packet theme data to the client.

Step S705: The client exhibits the red packet sending page to the user terminal.

After the server sends the red packet theme data to the client, the client preloads data related to the packet from the server, exhibits the red packet sending page, and keeps data synchronous when packet data stored in the server changes. The data related to the packet includes data of a plurality of themes.

Step S706: The user terminal selects a packet theme.

After the client exhibits the red packet sending page to the user terminal, the user terminal selects the packet theme from the red packet sending page of the client.

Step S707: The user terminal modifies a theme default blessing.

After the client exhibits the red packet sending page to the user terminal, the user terminal modifies the theme default blessing.

Step S708: The user terminal performs a red packet sending operation.

After the user terminal selects the packet theme and modifies the theme default blessing, the user terminal performs the red packet sending operation and may click a “send” key displayed on the red packet sending page to perform the red packet sending operation.

Step S709: The client performs red packet ordering.

After the user terminal performs the red packet sending operation, the client performs red packet ordering and sends an order to a sending server.

Step S710: The server puts an order into a warehouse and stores a theme ID.

After the client performs red packet ordering, the server puts the order into the warehouse and stores the theme ID.

Step S711: The server confirms that the ordering succeeds.

After the server puts the order into the warehouse and stores the theme ID, the server confirms, to the client, that the ordering succeeds.

Step S712: The client exhibits a red packet message with a theme in a chat window.

After the server confirms that the ordering succeeds, the client exhibits, in the chat window, the red packet message of the packet theme that is selected by the user terminal.

Step S713: The user terminal clicks the red packet message with a theme.

After the client exhibits the red packet message with a theme in the chat window, the user terminal clicks the red packet message with a theme.

Step S714: The client requests a red packet state.

After the user terminal clicks the red packet message with a theme, the client sends a request to the server, to request a current state of the red packet. The red packet state includes a total amount of a red packet, a state indicating whether the red packet is already grabbed, and the like.

Step S715: The server returns the red packet state.

After the client requests the red packet state, the server returns the red packet state.

Step S716: The client exhibits the theme packet and the blessing.

After the server returns to the red packet state, the client exhibits the theme packet and the blessing.

Step S717: A red packet is able to be grabbed; open the packet.

“A red packet is able to be grabbed” is displayed on a client receiving the red packet, and the user terminal receiving the red packet performs an operation of opening the received packet.

Step S718: A client receiving the red packet requests to grab the red packet.

When there is a plurality of clients receiving the red packet, the clients may all request to grab the red packet.

Step S719: The server updates related data.

As the client performs the operation of grabbing the red packet, the related data of the server continuously updates. After the client receiving the red packet requests to grab the red packet, the server updates the related data.

Step S720: The server returns the latest red packet message.

After the server updates the related data, the server returns the latest red packet message.

Step S721: The client receiving the red packet exhibits information such as grabbed amounts and a list of friends who grab the red packet.

After the server returns the latest red packet message to the client, the client receiving the red packet exhibits the grabbed amounts and also exhibits information such as the list of friends who grab the red packet, including data of amounts grabbed by the friends who grab the red packet.

In this embodiment, a user terminal clicks a “red packet” entry in a chat window; a client opens a red packet sending page; the client requests, from a server, red packet theme data; the server sends the red packet theme data to the client; the client exhibits the red packet sending page to the user terminal; the user terminal selects a packet theme; the user terminal modifies a theme default blessing; the user terminal performs a red packet sending operation; the client performs red packet ordering; the server puts an order into a warehouse and stores a theme ID; the server confirms that the ordering succeeds; the client exhibits a red packet message with a theme in a chat window; the user terminal clicks the red packet message with a theme; the client requests a red packet state; the server returns the red packet state; the client exhibits the theme packet and the blessing; a red packet is able to be grabbed, and the packet is opened; a client receiving the red packet requests to grab the red packet; the server updates related data; the server returns the latest red packet message; the client receiving the red packet exhibits information such as grabbed amounts and a list of friends who grab the red packet, to implement data pushing.

Optionally, the client in this embodiment may be a network platform that has a third-party payment capability such as an instant messaging communication application or a payment application.

In this embodiment, the packet theme is determined in the theme data of the plurality of theme pages provide by the server, an operation of pushing the target push data is performed on the red packet sending page according to the packet theme, and the theme page corresponding to the packet theme is displayed on the client receiving the red packet, to push data, to achieve a technical effect of satisfying diversified demands of data pushing when the data is pushed, to resolve a technical problem in the related technology that diversified demands of data pushing cannot be satisfied when the data is pushed.

An application environment in this embodiment of the present application may be but not limited to the application environment in the foregoing embodiment, and is not described in detail again in this embodiment. This embodiment of the present application provides an optional specific application for performing the foregoing data pushing method.

When the user uses a red packet function of the client of the instant messaging application for the first time, because the client cannot learn of a purpose for the user to send a red packet and objects to which the red packet is sent, orange with no religious feature is used as a default red packet color.

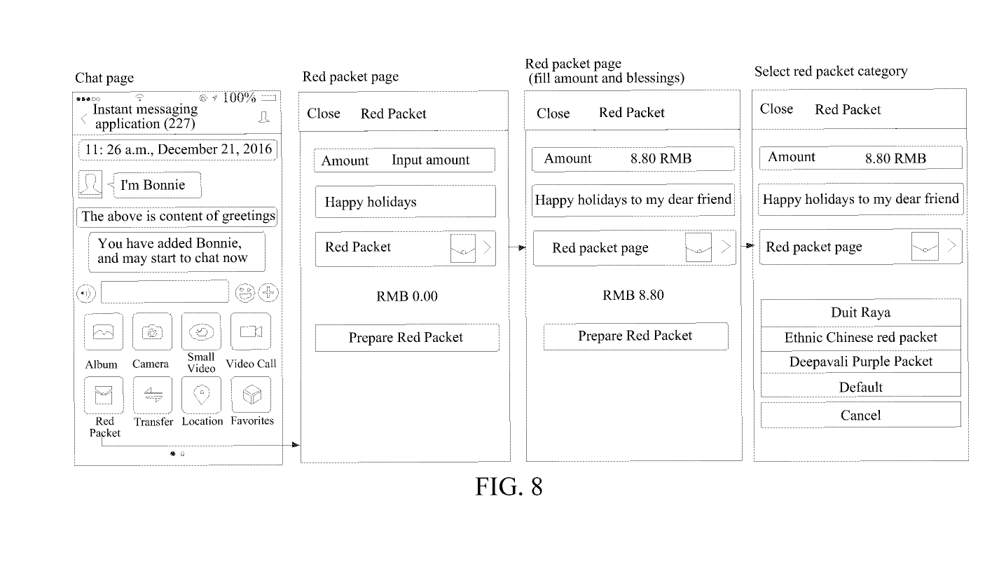

FIG. 8 is a schematic diagram of a page with a default theme according to an embodiment of the present application. As shown in FIG. 8, in a chat page of the client of the instant messaging application, an instruction is received through a “red packet” functional area, and a red packet page is opened. The red packet page is provided with a “close” key for closing the red packet page, an amount of the red packet may be set, the remark information is input, and the remark information is “Happy holidays” by default. The packet theme of the red packet may also be selected. On the red packet page, a setting instruction is received. The user fills amounts of the red packet, such as “8.80 RMB” and a blessing “Happy holidays to my dear friend”. A category of the red packet may also be selected. The category of the red packet may include a Duit Raya, an ethnic Chinese red packet, a Deepavali Purple Packet, and the like and is not limited herein. The Duit Raya is a green packet, where at the Hari Raya of the Malay, the elderly puts money in little green envelopes or wraps money with green papers, and distributes them one by one when children enters the door. Patterns of the green packet are mainly mosques, the Koran, and ethnic customs and patterns. The ethnic Chinese red packet may be a traditional Chinese red packet. The Deepavali Purple Packet is a purple packet that is sent by local Indians to relatives and friends and that contains money. Patterns of the purple packets are mostly Gods and Buddhas, peacocks, magic lamps, dances, and the like. The red packet may be a default red packet, for example, still an orange theme page.

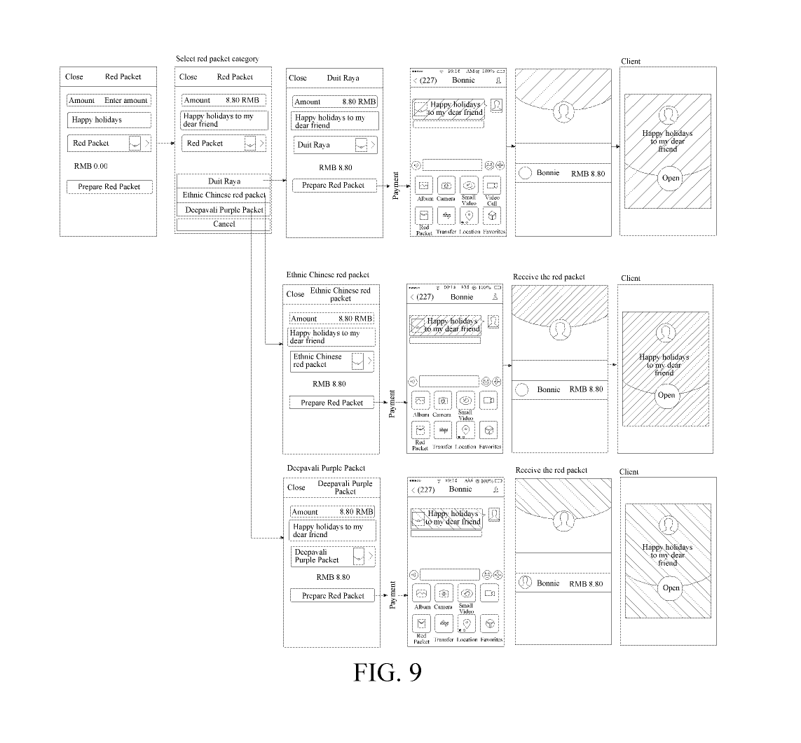

FIG. 9 is a schematic diagram of a page selecting a red packet category according to an embodiment of the present application. As shown in FIG. 9, the user may change red packet categories according to festivals and objects to which packets are sent. The red packet categories for the user to select may include a Duit Raya, an ethnic Chinese red packet, and a Deepavali Purple Packet. After the user selects different red packets, colors and textures of the red packets change. The red packet page is provided with a “close” key for closing the red packet page, an amount of the red packet may be set, the remark information is input, and the remark information is “Happy holidays” by default. The packet theme of the red packet may also be selected. On the red packet page, a setting instruction is received. The user fills amounts of the red packet, such as “8.80 RMB” and a blessing “Happy holidays to my dear friend”.

When a “Duit Raya” is selected for the red packet category, a page of the Duit Raya is exhibited, a Duit Raya theme is displayed, and the packet is a packet of the Duit Raya. After the red packet is prepared, payment is conducted, and the red packet is sent to a friend account. In this case, a red packet message “Happy holidays to my dear friend” is displayed, and the color is green. The red packet is received on the client receiving the red packet. The page of receiving the red packet corresponds to a green theme of the Duit Raya, and the color is green (as shown in diagonal stripes in the Duit Raya in FIG. 9). The user clicks a page of receiving the red packet, and a page of opening the Duit Raya is displayed on the client receiving the red packet and includes a green theme of the Duit Raya and a blessing “Happy holidays to my dear friend”. When the user clicks “Open”, red packet cash is automatically transferred to a balance account of a wallet of an instant messaging application of the user, to well satisfy data pushing demands in a service background of a plurality of ethnic groups of Malaysia.

When an “ethnic Chinese red packet” is selected for the red packet category, a page of the ethnic Chinese red packet is exhibited, an ethnic Chinese red packet theme is displayed, and the packet is a packet of the ethnic Chinese red packet. After the red packet is prepared, payment is conducted, and the red packet is sent to a friend account. In this case, a red packet message “Happy holidays to my dear friend” is displayed, and the color is red. The red packet is received on the client receiving the red packet. The page of receiving the red packet corresponds to a red theme of the ethnic Chinese red packet, and the color is red (as shown in diagonal stripes in the ethnic Chinese red packet in FIG. 9). The user clicks a page of receiving the red packet, and a page of opening the ethnic Chinese red packet is displayed on the client receiving the red packet and includes a red theme of the ethnic Chinese red packet and a blessing “Happy holidays to my dear friend”. When the user clicks “Open”, red packet cash is automatically transferred to a balance account of a wallet of an instant messaging application of the user, to well satisfy data pushing demands in a service background of the ethnic Chinese.

When a “Deepavali Purple Packet” is selected for the red packet category, a page of the Deepavali Purple Packet is exhibited, a Deepavali Purple Packet theme is displayed, and the packet is a packet of the Deepavali Purple Packet. After the red packet is prepared, payment is conducted, and the red packet is sent to a friend account. In this case, a red packet message “Happy holidays to my dear friend” is displayed, and the color is purple. The red packet is received on the client receiving the red packet. The page receiving the red packet corresponds to a purple theme of the Deepavali Purple Packet, and the color is purple (as shown in diagonal stripes in the Deepavali Purple Packet in FIG. 9). The user clicks a page of receiving the red packet, and a page of opening the red packet is displayed on the client receiving the red packet and includes a purple theme of the Deepavali Purple Packet and a blessing “Happy holidays to my dear friend”. When the user clicks “Open”, red packet cash is automatically transferred to a balance account of a wallet of an instant messaging application of the user, to well satisfy data pushing demands in a service background of Indian religions.

After filling the red packet amount and selecting the red packet category, the user may prepare the red packet and send the red packet to a client corresponding to a packet receiver. A different red packet category is selected according to a packet sender, and the client corresponding to the packet receiver receives a red packet with the corresponding color and texture.

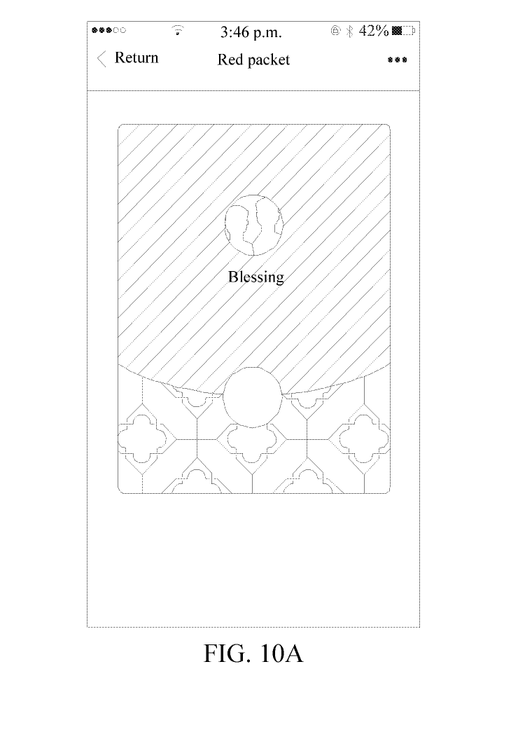

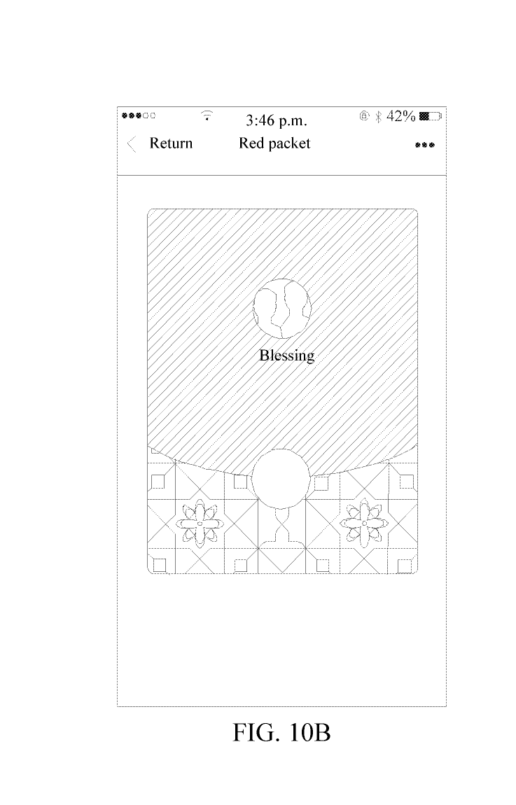

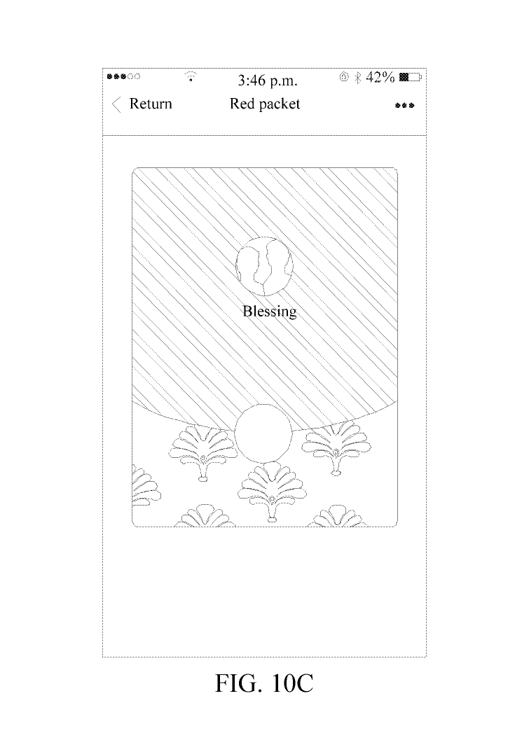

FIG. 10A is a schematic diagram of a page for a client to receive a red packet according to an embodiment of the present application. A chat window that is provided when the client receives a Duit Raya is shown in FIG. 10A and displays a red packet page corresponding to a Duit Raya theme, the color is green (as shown in diagonal stripes in the Duit Raya in FIG. 10A), the texture may be a mosque, the Koran, and an ethnic custom and pattern, or the like, and a blessing is displayed.

FIG. 10B is a schematic diagram of another page for a client to receive a red packet according to an embodiment of the present application. A chat window that is provided when the client receives an ethnic Chinese red packet is shown in FIG. 10B and displays a red packet page corresponding to an ethnic Chinese red packet theme, the color is red (as shown in diagonal stripes in the ethnic Chinese red packet in FIG. 10B), the texture may be a pattern such as a peony, and a blessing is displayed.

FIG. 10C is a schematic diagram of another page for a client to receive a red packet according to an embodiment of the present application. A chat window that is provided when the client receives a Deepavali Purple Packet is shown in FIG. 10C and displays a red packet page corresponding to a Deepavali Purple Packet theme, the color is purple (as shown in diagonal stripes in the Deepavali Purple Packet in FIG. 10C), the texture may be a God and Buddha, a peacock, a magic lamp, a dance, or the like, and a blessing is displayed.

The user clicks the packet on the client, the packet is opened, a received red packet amount is exhibited, and a page of the corresponding color and texture is displayed.

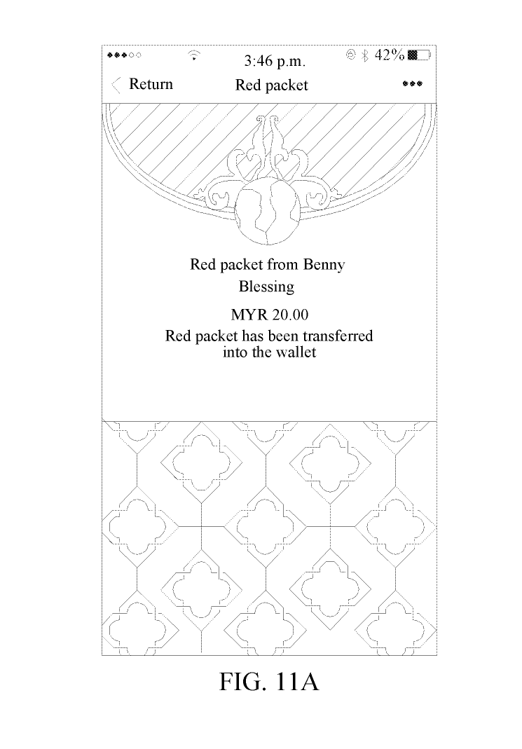

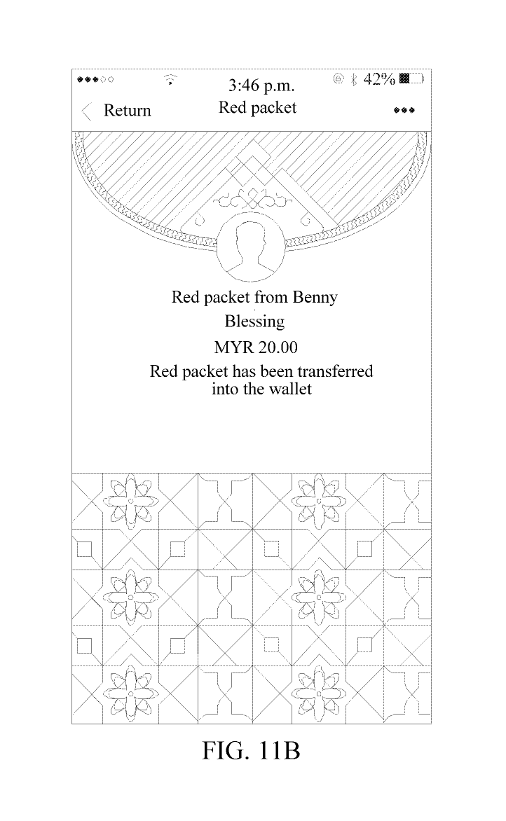

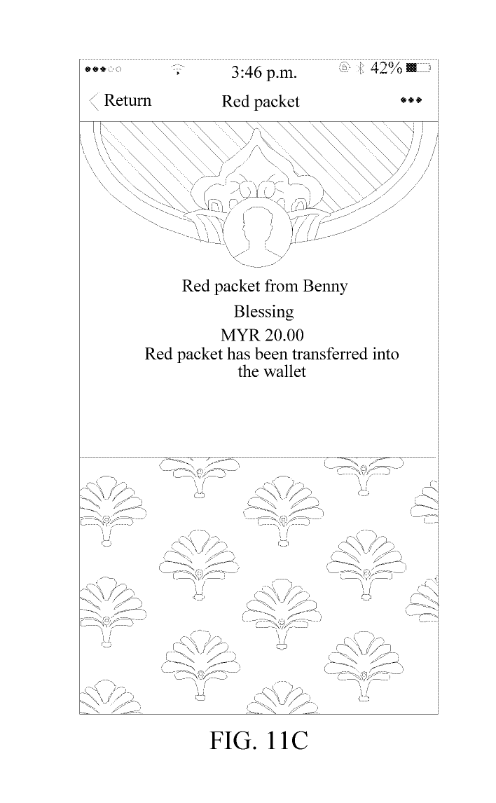

FIG. 11A is a schematic diagram of a page for a client to open a red packet according to an embodiment of the present application. As shown in FIG. 11A, after the user clicks the red packet page under the Duit Raya theme, the packet of the Duit Raya is opened, a red packet opening page under the Duit Raya theme is displayed, the color is green (as shown in diagonal stripes in the Duit Raya in FIG. 11A), the texture is a texture under the Duit Raya theme, and “Red packet from Benny”, “Blessing”, and “Red packet amount MYR20.00”, and prompt information “Red packet has been transferred into the wallet” may be displayed.

FIG. 11B is a schematic diagram of another page for a client to open a red packet according to an embodiment of the present application. As shown in FIG. 11B, after the user clicks the red packet page under the ethnic Chinese red packet theme, the packet of the ethnic Chinese red packet is opened, a red packet opening page under the ethnic Chinese red packet theme is displayed, the color is red (as shown in diagonal stripes in the ethnic Chinese red packet in FIG. 11B), the texture is a texture under the ethnic Chinese red packet theme, and “Red packet from Benny”, “Blessing”, and “Red packet amount MYR20.00”, and prompt information “Red packet has been transferred into the wallet” may be displayed.

FIG. 11C is a schematic diagram of another page for a client to open a red packet according to an embodiment of the present application. As shown in FIG. 11C, after the user clicks the red packet page under the Deepavali Purple Packet theme, the packet of the Deepavali Purple Packet is opened, a red packet opening page under the Deepavali Purple Packet theme is displayed, the color is purple (as shown in diagonal stripes in the Deepavali Purple Packet in FIG. 11C), the texture is a texture under the Deepavali Purple Packet theme, and “Red packet from Benny”, “Blessing”, and “Red packet amount MYR20.00”, and prompt information “Red packet has been transferred into the wallet” may be displayed.

Optionally, an animation element related to a festival may be added to the theme packet to increase user reputation and enthusiasm for user propagation. For example, on a Lunar New Year red packet, an animation element of setting off firecrackers may be added. Limitations are not made herein.

The background of this embodiment stores data related to a multi-cultural packet, including the packet color, a texture pattern, and a default blessing corresponding to the theme. The client preloads the packet related data from the background and keeps the data of the client synchronous when the background packet data changes. In a process in which a Malaysian user sends a red packet, the client exhibits a plurality of theme packets. The user selects one theme packet and distributes the theme packet to a friend in a chat window. In this case, the chat window displays a red packet message that is consistent with the color and the texture pattern of the selected theme packet. After a friend user clicks the red packet message, the client exhibits a corresponding theme packet and blessing, and red packet cash is automatically transferred to a balance account of a wallet of an instant messaging application of the user, to achieve flexibility and meet the objective of a plurality of digital red packet distribution modes accustomed by the user.

According to another aspect of the embodiments of the present application, a data pushing apparatus for performing the foregoing data pushing method is further provided. The data pushing apparatus includes one or more processors and one or more memories storing program modules, the program modules being executed by the processor, and the program modules including: an obtaining unit, a selection unit, and a pushing unit.

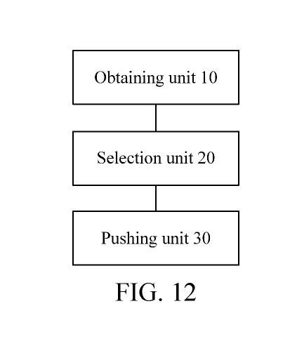

FIG. 12 is a schematic diagram of a data pushing apparatus according to an embodiment of the present application. As shown in FIG. 12, the data pushing apparatus may include: an obtaining unit 10, a selection unit 20, and a pushing unit 30.

The obtaining unit 10 is configured to obtain a plurality of pieces of theme data that is to be selected when target push data is pushed, the plurality of pieces of theme data being used for displaying different theme pages of the target push data.

The selection unit 20 is configured to select, from the plurality of pieces of theme data, target theme data that is used when the target push data is pushed.

The pushing unit 30 is configured to push the target push data to a second client and display, on a first client, a first target theme page that is obtained after the target push data is pushed when a first instruction of the first client is received, and display a second target theme page corresponding to the first target theme page on the second client after the second client receives the target push data, the first instruction being used for instructing to push the target push data to the second client, the first client logging in to a first account, and the second client logging in to a second account.

It should be noted herein that the obtaining unit 10, the selection unit 20, and the pushing unit 30 may be run in a terminal as a part of the apparatus, functions implemented by the foregoing units may be performed by using a processor in the terminal, and the terminal may also be a terminal device such as a smartphone (for example, an Android mobile phone or an iOS mobile phone), a tablet computer, a palmtop computer, a mobile Internet device (MID), or a PAD.

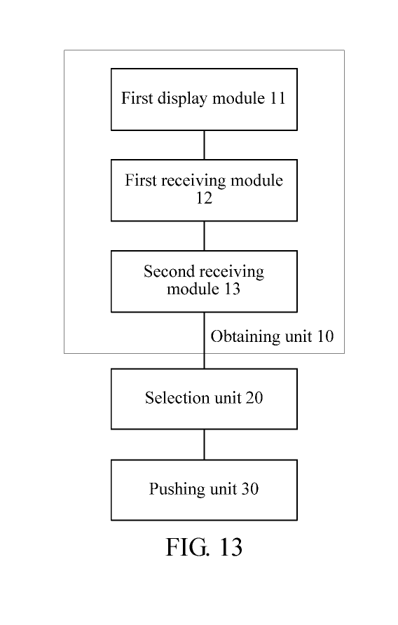

FIG. 13 is a schematic diagram of another data pushing apparatus according to an embodiment of the present application. As shown in FIG. 13, the data pushing apparatus may include: an obtaining unit 10, a selection unit 20, and a pushing unit 30. The obtaining unit 10 includes: a first display module 11, a first receiving module 12, and a second receiving module 13.

It should be noted that the obtaining unit 10, the selection unit 20, and the pushing unit 30 in this embodiment have the same functions as the data pushing apparatus in the embodiment shown in FIG. 12 and are not described in detail herein again.

The first display module 11 is configured to display, on the first client, an interactive window used by the first account and the second account to perform a data exchange event.

The first receiving module 12 is configured to receive a second instruction through the interactive window, the second instruction being used for instructing to display a first preset page and requesting, from a server, the plurality of pieces of theme data, the first preset page being used for prompting the first account to set the target push data.

The second receiving module 13 is configured to receive the plurality of pieces of theme data that is sent by the server according to the second instruction.

It should be noted herein that the first display module 11, the first receiving module 12, and the second receiving module 13 may be run in the terminal as a part of the apparatus, or functions implemented by the foregoing modules may be executed by using the processor in the terminal.

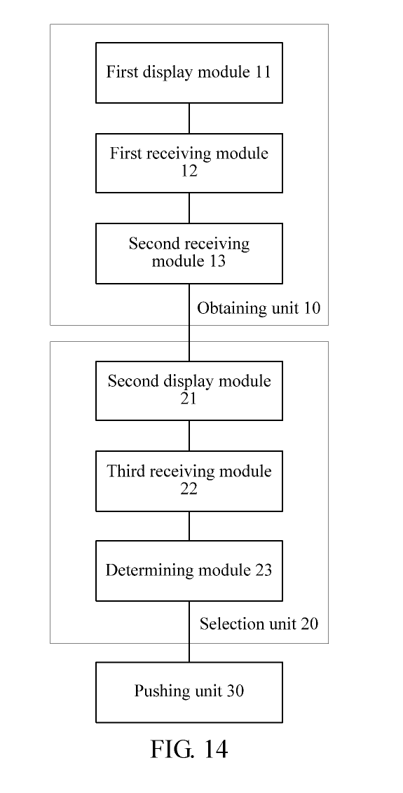

FIG. 14 is a schematic diagram of another data pushing apparatus according to an embodiment of the present application. As shown in FIG. 14, the data pushing apparatus may include: an obtaining unit 10, a selection unit 20, and a pushing unit 30. The obtaining unit 10 includes: a first display module 11, a first receiving module 12, and a second receiving module 13. The selection unit 20 includes: a second display module 21, a third receiving module 22, and a determining module 23.

It should be noted that the obtaining unit 10, the selection unit 20, the pushing unit 30, the first display module 11, the first receiving module 12, and the second receiving module 13 in this embodiment have the same functions as the data pushing apparatus in the embodiment shown in FIG. 13 and are not described in detail herein again.

The second display module 21 is configured to display a plurality of preset identifiers in one-to-one correspondence with the plurality of pieces of theme data on the first preset page.

The third receiving module 22 is configured to receive a third instruction in a predetermined area of the first preset page, the third instruction being used for instructing to select a target preset identifier from the plurality of preset identifiers, the target preset identifier corresponding to the target theme data.

The determining module 23 is configured to determine the target theme data according to the target preset identifier.

It should be noted herein that the second display module 21, the third receiving module 22, and the determining module 23 may be run in the terminal as a part of the apparatus, or functions implemented by the foregoing modules may be executed by using the processor in the terminal.

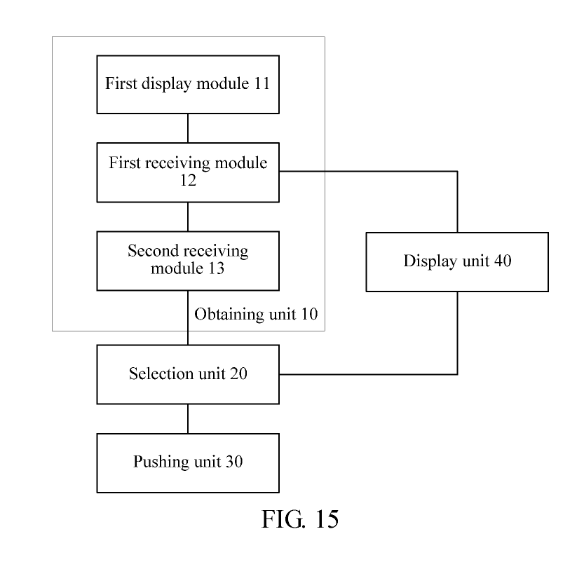

FIG. 15 is a schematic diagram of another data pushing apparatus according to an embodiment of the present application. As shown in FIG. 15, the data pushing apparatus may include: an obtaining unit 10, a selection unit 20, and a pushing unit 30. The obtaining unit 10 includes: a first display module 11, a first receiving module 12, and a second receiving module 13. The apparatus further includes a display unit 40.

It should be noted that the obtaining unit 10, the selection unit 20, the pushing unit 30, the first display module 11, the first receiving module 12, and the second receiving module 13 in this embodiment have the same functions as the data pushing apparatus in the embodiment shown in FIG. 13 and are not described in detail herein again.

The display unit 40 is configured to display the first preset page as a page with a default theme after the second instruction is received through the interactive window and before the target theme data that is used when the target push data is pushed is selected from the plurality of pieces of theme data.

It should be noted herein that the display unit 40 may be run in the terminal as a part of the apparatus, or a function implemented by the foregoing unit may be executed by using the processor in the terminal.

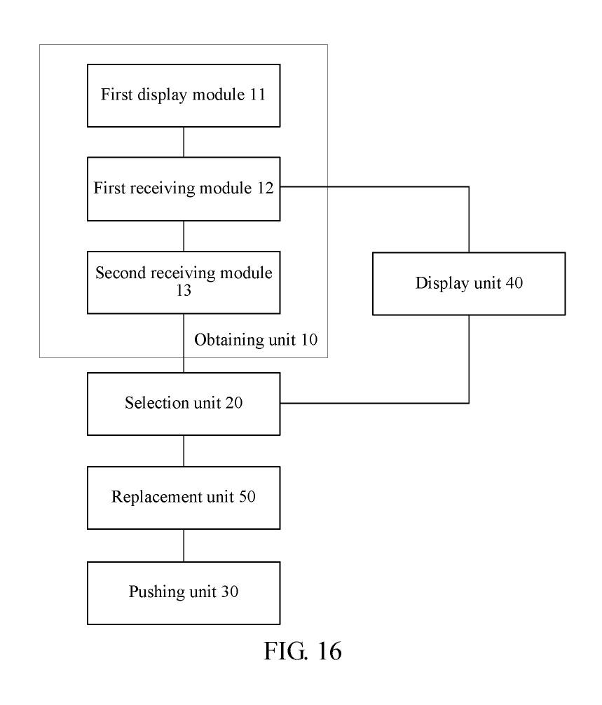

FIG. 16 is a schematic diagram of another data pushing apparatus according to an embodiment of the present application. As shown in FIG. 16, the data pushing apparatus may include: an obtaining unit 10, a selection unit 20, and a pushing unit 30. The obtaining unit 10 includes: a first display module 11, a first receiving module 12, and a second receiving module 13. The apparatus further includes a display unit 40 and further includes a replacement unit 50.

It should be noted that the obtaining unit 10, the selection unit 20, the pushing unit 30, the first display module 11, the first receiving module 12, the second receiving module 13, and the display unit 40 in this embodiment have the same functions as the data pushing apparatus in the embodiment shown in FIG. 15 and are not described in detail herein again.

The replacement unit 50 is configured to replace, after the target theme data that is used when the target push data is pushed is selected from the plurality of pieces of theme data, the page with the default theme with a second preset page according to the target theme data, the second preset page matching the target theme data.

It should be noted herein that the replacement unit 50 may be run in the terminal as a part of the apparatus, or a function implemented by the foregoing unit may be executed by using the processor in the terminal.

Optionally, the pushing unit 30 is configured to perform at least one of the following steps: instructing the second client to display the second target theme page having a correspondence with the first target theme page when the target push data is pushed to the second client, the first target theme page including a first color, the second target theme page including a second color, and the first target color corresponding to the second target color; instructing the second client to display the second target theme page having a correspondence with the first target theme page when the target push data is pushed to the second client, the first target theme page including a first texture, the second target theme page including a second texture, and the first texture corresponding to the second texture; and instructing the second client to display the second target theme page having a correspondence with the first target theme page when the target push data is pushed to the second client, the first target theme page including a first animation element, the second target theme page including a second animation element, and the first animation element corresponding to the second animation element.

Optionally, the selection unit 20 includes: a first determining module, configured to determine the target theme data corresponding to a preset date in the plurality of pieces of theme data when a current date is the preset date; and/or determine the target theme data corresponding to a preset condition in the plurality of pieces of theme data when the second account meets the preset condition.

It should be noted herein that the first determining module may be run in the terminal as a part of the apparatus, or a function implemented by the foregoing module may be executed by using the processor in the terminal.

Optionally, the apparatus further includes: a first display unit, configured to display a third theme page corresponding to the second target theme page and display the target push data on the third theme page when the second client receives a fourth instruction after the target push data is pushed to the second client, the fourth instruction being used for instructing the second client to display the third theme page.

It should be noted herein that the first display unit may be run in the terminal as a part of the apparatus, or a function implemented by the foregoing unit may be executed by using the processor in the terminal.

Optionally, the apparatus further includes: a receiving unit and a first obtaining unit. The receiving unit is configured to receive a first setting instruction of the first account through the first client before the target push data is pushed to the second client, the first setting instruction being used for instructing to set the target push data. The first obtaining unit is configured to obtain the target push data according to the first setting instruction.

Optionally, before the target push data is pushed to the second client, a second setting instruction of the first account is received through the first client, the second setting instruction being used for instructing to set remark information of the target push data. The pushing unit 30 includes a pushing module, configured to push the target push data and the remark information to the second client.

It should be noted herein that the pushing module may be run in the terminal as a part of the apparatus, or a function implemented by the foregoing module may be executed by using the processor in the terminal.

It should be noted that the obtaining unit 10 in this embodiment may be configured to perform step S202 in the embodiments of this application, the selection unit 20 in this embodiment may be configured to perform step S204 in the embodiments of this application, and the pushing unit 30 in this embodiment may be configured to perform step S206 in the embodiments of this application.

In this embodiment, the obtaining unit 10 obtains a plurality of pieces of theme data that is to be selected when target push data is pushed, the plurality of pieces of theme data being used for displaying different theme pages of the target push data; the selection unit 20 selects, from the plurality of pieces of theme data, target theme data that is used when the target push data is pushed. The pushing unit 30 pushes the target push data to a second client and displays, on a first client, a first target theme page that is obtained after the target push data is pushed when a first instruction of the first client is received, and displays a second target theme page corresponding to the first target theme page on the second client after the second client receives the target push data, the first instruction being used for instructing to push the target push data to the second client, the first client logging in to a first account, and the second client logging in to a second account. The theme data of the plurality of theme pages is provided, the target theme data is determined in the plurality of pieces of theme data, the target push data is pushed in a form of the first target theme page according to the target theme data, and the second target theme page corresponding to the first target theme page is displayed on the second client, to push data, to achieve a technical effect of satisfying diversified demands of data pushing when data is pushed, to resolve the technical problem in the related technology that diversified demands of data pushing cannot be satisfied when data is pushed.

It should be noted herein that, examples and application scenarios implemented by the foregoing units and modules and the corresponding steps are the same, but are not limited to the content disclosed in the foregoing embodiments. It should be noted that the foregoing modules may be run in the hardware environment shown in FIG. 1 as a part of the apparatus, and may be implemented through software, or may be implemented through hardware. The hardware environment includes a network environment.

According to another aspect of the embodiments of the present application, a server or terminal for performing the data pushing method is further provided.

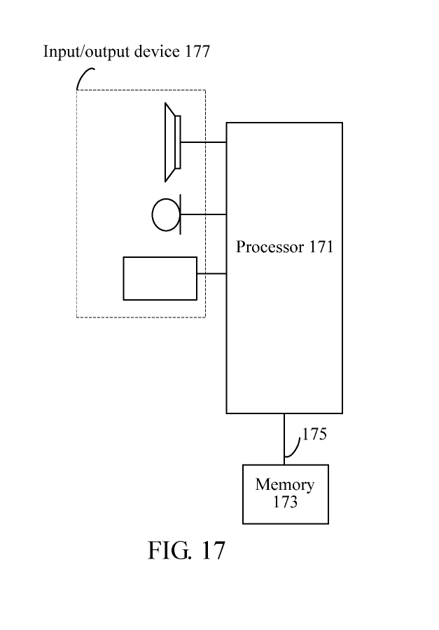

FIG. 17 is a structural block diagram of an electronic apparatus according to an embodiment of the present application. As shown in FIG. 17, the terminal may include: one or more (only one is shown in the figure) processors 171, a memory 173, and a transmission apparatus 175. As shown in FIG. 17, the terminal may further include an input/output device 177.

The memory 173 may be configured to store software programs and modules, for example, program instructions/modules corresponding to the data pushing method and apparatus in the embodiments of the present application. The processor 171 is configured to run the software programs and modules stored in the memory 173, to perform various functional applications and data processing, to be specific, implement the data pushing method. The memory 173 may include a high-speed random memory, and may also include a nonvolatile memory such as one or more magnetic storage apparatuses, a flash memory, or another nonvolatile solid-state memory. In some embodiments, the memory 173 may further include memories remotely disposed relative to the processor 171, and these remote memories may be connected to the terminal through a network. Examples of the network include, but are not limited to, the Internet, an intranet, a local area network, a mobile communications network, and a combination thereof.

The transmission apparatus 175 is configured to receive or send data via a network and may further be configured to transmit data of the processor and the memory. Specific examples of the foregoing network may include a wired network and a wireless network. In an embodiment, the transmission apparatus 175 includes a network interface controller (NIC) that may be connected to another network device and a router by using a network cable, thereby communicating with the Internet or a local area network. In an embodiment, the transmission apparatus 175 is a radio frequency (RF) module that is configured to communicate with the Internet in a wireless manner.

Specifically, the memory 173 is configured to store an application program.

The processor 171 may invoke, by using the transmission apparatus 175, the application program stored in the memory 173, so as to perform the following steps:

obtaining a plurality of pieces of theme data that is to be selected when target push data is pushed, the plurality of pieces of theme data being used for displaying different theme pages of the target push data;

selecting, from the plurality of pieces of theme data, target theme data that is used when the target push data is pushed; and

pushing the target push data to a second client and displaying, on a first client, a first target theme page that is obtained after the target push data is pushed when a first instruction of the first client is received, and displaying a second target theme page corresponding to the first target theme page on the second client after the second client receives the target push data, the first instruction being used for instructing to push the target push data to the second client, the first client logging in to a first account, and the second client logging in to a second account.

The processor 171 is further configured to perform the following steps: displaying, on the first client, an interactive window used by the first account and the second account to perform a data exchange event; receiving a second instruction through the interactive window, the second instruction being used for instructing to display a first preset page and requesting, from a server, the plurality of pieces of theme data, the first preset page being used for prompting the first account to set the target push data; and receiving the plurality of pieces of theme data that is sent by the server according to the second instruction.

The processor 171 is further configured to perform the following steps: displaying a plurality of preset identifiers in one-to-one correspondence with the plurality of pieces of theme data on the first preset page; receiving a third instruction in a predetermined area of the first preset page, the third instruction being used for instructing to select a target preset identifier from the plurality of preset identifiers, the target preset identifier corresponding to the target theme data; and determining the target theme data according to the target preset identifier.

The processor 171 is further configured to perform the following steps: after the second instruction is received through the interactive window and the target theme data that is used when the target push data is pushed is selected from the plurality of pieces of theme data, displaying the first preset page as a page with a default theme.

The processor 171 is further configured to perform the following steps: after the target theme data that is used when the target push data is pushed is selected from the plurality of pieces of theme data, replacing the page with the default theme with a second preset page according to the target theme data, the second preset page matching the target theme data.

The processor 171 is further configured to perform at least one of the following steps: instructing the second client to display the second target theme page having a correspondence with the first target theme page when the target push data is pushed to the second client, the first target theme page including a first color, the second target theme page including a second color, and the first target color corresponding to the second target color; instructing the second client to display the second target theme page having a correspondence with the first target theme page when the target push data is pushed to the second client, the first target theme page including a first texture, the second target theme page including a second texture, and the first texture corresponding to the second texture; and instructing the second client to display the second target theme page having a correspondence with the first target theme page when the target push data is pushed to the second client, the first target theme page including a first animation element, the second target theme page including a second animation element, and the first animation element corresponding to the second animation element.

The processor 171 is further configured to perform the following steps: determining the target theme data corresponding to a preset date in the plurality of pieces of theme data when a current date is the preset date; and/or determining the target theme data corresponding to a preset condition in the plurality of pieces of theme data when the second account meets the preset condition.

The processor 171 is further configured to perform the following steps: after the target push data is pushed to the second client, displaying a third theme page corresponding to the second target theme page and displaying the target push data on the third theme page when the second client receives a fourth instruction, the fourth instruction being used for instructing the second client to display the third theme page.

The processor 171 is further configured to perform the following steps: before the target push data is pushed to the second client, receiving a first setting instruction of the first account through the first client, the first setting instruction being used for instructing to set the target push data; and obtaining the target push data according to the first setting instruction.

The processor 171 is further configured to perform the following steps: before the target push data is pushed to the second client, receiving a second setting instruction of the first account through the first client, the second setting instruction being used for instructing to set remark information of the target push data; and the pushing the target push data to a second client includes: pushing the target push data and the remark information to the second client.

In this embodiment of the present application, a plurality of pieces of theme data that is to be selected when target push data is pushed is obtained, the plurality of pieces of theme data being used for displaying different theme pages of the target push data; target theme data that is used when the target push data is pushed is selected from the plurality of pieces of theme data; and the target push data is pushed to a second client and a first target theme page that is obtained after the target push data is pushed is displayed on a first client when a first instruction of the first client is received, and a second target theme page corresponding to the first target theme page is displayed on the second client after the second client receives the target push data, the first instruction being used for instructing to push the target push data to the second client, the first client logging in to a first account, and the second client logging in to a second account. The theme data of the plurality of theme pages is provided, the target theme data is determined in the plurality of pieces of theme data, the target push data is pushed in a form of the first target theme page according to the target theme data, and the second target theme page corresponding to the first target theme page is displayed on the second client, to push data, to achieve a technical effect of satisfying diversified demands of data pushing when data is pushed, to resolve the technical problem in the related technology that diversified demands of data pushing cannot be satisfied when data is pushed.

Optionally, refer to the examples described in the foregoing embodiments for specific examples in this embodiment. Details are not described in this embodiment.

A person of ordinary skill in the art may understand that, the structure shown in FIG. 17 is only schematic. Alternatively, the electronic apparatus may be a terminal device such as a smartphone (such as an Android mobile phone or an iOS mobile phone), a tablet computer, a palmtop computer, a mobile Internet device (MID), or a PAD. FIG. 17 does not limit the structure of the foregoing electronic apparatus. For example, the electronic apparatus may further include more or fewer components (such as a network interface and a display apparatus) than those shown in FIG. 17, or have a configuration different from that shown in FIG. 17.

A person of ordinary skill in the art may understand that all or some of the steps of the methods of the foregoing embodiments may be implemented by a program instructing relevant hardware of the terminal device. The program may be stored in a computer readable storage medium. The storage medium may be a flash disk, a read-only memory (ROM), a random access memory (RAM), a magnetic disk, or an optical disc.

This embodiment of the present application further provides a storage medium. Optionally, in this embodiment, the storage medium stores a computer program. The computer program, when run, is configured to perform the data pushing method.

Optionally, in this embodiment, the storage medium may be located in at least one of a plurality network devices in the network shown in the foregoing embodiments.

Optionally, in this embodiment, the storage medium is configured to store program code for performing the following steps:

obtaining a plurality of pieces of theme data that is to be selected when target push data is pushed, the plurality of pieces of theme data being used for displaying different theme pages of the target push data;

selecting, from the plurality of pieces of theme data, target theme data that is used when the target push data is pushed; and

pushing the target push data to a second client and displaying, on a first client, a first target theme page that is obtained after the target push data is pushed when a first instruction of the first client is received, and displaying a second target theme page corresponding to the first target theme page on the second client after the second client receives the target push data, the first instruction being used for instructing to push the target push data to the second client, the first client logging in to a first account, and the second client logging in to a second account.

Optionally, the storage medium is further configured to store program code for performing the following steps: displaying, on the first client, an interactive window used by the first account and the second account to perform a data exchange event; receiving a second instruction through the interactive window, the second instruction being used for instructing to display a first preset page and requesting, from a server, the plurality of pieces of theme data, the first preset page being used for prompting the first account to set the target push data; and receiving the plurality of pieces of theme data that is sent by the server according to the second instruction.

Optionally, the storage medium is further configured to store program code for performing the following steps: displaying a plurality of preset identifiers in one-to-one correspondence with the plurality of pieces of theme data on the first preset page; receiving a third instruction in a predetermined area of the first preset page, the third instruction being used for instructing to select a target preset identifier from the plurality of preset identifiers, the target preset identifier corresponding to the target theme data; and determining the target theme data according to the target preset identifier.

Optionally, the storage medium is further configured to store program code for performing the following steps: after the second instruction is received through the interactive window and the target theme data that is used when the target push data is pushed is selected from the plurality of pieces of theme data, displaying the first preset page as a page with a default theme.

Optionally, the storage medium is further configured to store program code for performing the following steps: after the target theme data that is used when the target push data is pushed is selected from the plurality of pieces of theme data, replacing the page with the default theme with a second preset page according to the target theme data, the second preset page matching the target theme data.

Optionally, the storage medium is further configured to store program code for performing the following steps: instructing the second client to display the second target theme page having a correspondence with the first target theme page when the target push data is pushed to the second client, the first target theme page including a first color, the second target theme page including a second color, and the first target color corresponding to the second target color; instructing the second client to display the second target theme page having a correspondence with the first target theme page when the target push data is pushed to the second client, the first target theme page including a first texture, the second target theme page including a second texture, and the first texture corresponding to the second texture; and instructing the second client to display the second target theme page having a correspondence with the first target theme page when the target push data is pushed to the second client, the first target theme page including a first animation element, the second target theme page including a second animation element, and the first animation element corresponding to the second animation element.

Optionally, the storage medium is further configured to store program code for performing the following steps: determining the target theme data corresponding to a preset date in the plurality of pieces of theme data when a current date is the preset date; and/or determining the target theme data corresponding to a preset condition in the plurality of pieces of theme data when the second account meets the preset condition.

Optionally, the storage medium is further configured to store program code for performing the following steps: after the target push data is pushed to the second client, displaying a third theme page corresponding to the second target theme page and displaying the target push data on the third theme page when the second client receives a fourth instruction, the fourth instruction being used for instructing the second client to display the third theme page.

Optionally, the storage medium is further configured to store program code for performing the following steps: before the target push data is pushed to the second client, receiving a first setting instruction of the first account through the first client, the first setting instruction being used for instructing to set the target push data; and obtaining the target push data according to the first setting instruction.

Optionally, the storage medium is further configured to store program code for performing the following steps: before the target push data is pushed to the second client, receiving a second setting instruction of the first account through the first client, the second setting instruction being used for instructing to set remark information of the target push data; and the pushing the target push data to a second client includes: pushing the target push data and the remark information to the second client.

Optionally, refer to the examples described in the foregoing embodiments for specific examples in this embodiment. Details are not described in this embodiment.

Optionally, in this embodiment, the foregoing storage medium may include but is not limited to: any medium that can store program code, such as a USB flash drive, a ROM, a RAM, a removable hard disk, a magnetic disk, or an optical disc.

The data pushing method and apparatus, the storage medium, and the electronic apparatus according to the present disclosure are described above by using examples with reference to the accompanying drawings. However, a person skilled in the art should understand that, various improvements may be further made for the data pushing method and apparatus, the storage medium, and the electronic apparatus proposed in the present disclosure without departing from content of the present disclosure. Therefore, the protection scope of the present disclosure should be subject to content of the appended claims.

The sequence numbers of the preceding embodiments of the present application are merely for description purpose but do not indicate the preference of the embodiments.

If the integrated units in the foregoing embodiments are implemented in a form of software functional units and are sold or used as an independent product, the units may be stored in a computer readable storage medium. Based on such an understanding, the technical solutions of the present disclosure essentially, or the part contributing to the existing technology, or all or a part of the technical solutions may be implemented in a form of a software product. The computer software product is stored in a storage medium and includes several instructions for instructing one or more computer devices (which may be a personal computer, a server, a network device, or the like) to perform all or a part of steps of the methods described in the embodiments of the present application.

In the foregoing embodiments of the present application, the descriptions of the embodiments have respective focuses. For a part not described in detail in an embodiment, refer to a related description of another embodiment.

In the several embodiments provided in the present application, it should be understood that the disclosed client may be implemented in other manners. The described apparatus embodiments are merely schematic. For example, division of the units is merely division of logic functions, and there may be another division manner during actual implementation. For example, multiple units or components may be combined or may be integrated into another system, or some features may be omitted or not be executed. In addition, the displayed or discussed mutual coupling, or direct coupling, or communication connections may be implemented through some interfaces. Indirect coupling or communication connections between the units or modules may be implemented in electronic or other forms.

The units described as separate parts may or may not be physically separate, and the parts displayed as units may or may not be physical units, may be located in one position, or may be distributed on a plurality of network units. Some of or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated units may be implemented in a form of hardware or may be implemented in a form of a software functional unit.

The foregoing descriptions are merely preferred implementations of the present disclosure. It should be noted that a person of ordinary skill in the art may make several improvements or polishing without departing from the principle of the present disclosure, and the improvements or polishing shall also fall within the protection scope of the present disclosure.

### INDUSTRIAL APPLICABILITY

In the embodiments of the present application, a plurality of pieces of theme data that is to be selected when target push data is pushed is obtained, the plurality of pieces of theme data being used for displaying different theme pages of the target push data; target theme data that is used when the target push data is pushed is selected from the plurality of pieces of theme data; and the target push data is pushed to a second client and a first target theme page that is obtained after the target push data is pushed is displayed on a first client when a first instruction of the first client is received, and a second target theme page corresponding to the first target theme page is displayed on the second client after the second client receives the target push data, the first instruction being used for instructing to push the target push data to the second client, the first client logging in to a first account, and the second client logging in to a second account. The theme data of the plurality of theme pages is provided, the target theme data is determined in the plurality of pieces of theme data, the target push data is pushed in a form of the first target theme page according to the target theme data, and the second target theme page corresponding to the first target theme page is displayed on the second client, to push data, to achieve a technical effect of satisfying diversified demands of data pushing when data is pushed, to resolve the technical problem in the related technology that diversified demands of data pushing cannot be satisfied when data is pushed.

What is claimed is:

1. A data pushing method performed at a server having one or more processors and memory storing a plurality of operations to be executed by the one or more processors, the method comprising:
obtaining a plurality of pieces of theme data that is to be selected when target push data is pushed via a social networking application, the plurality of pieces of theme data being used for displaying different theme pages of the target push data;
selecting, from the plurality of pieces of theme data, target theme data that is used when the target push data is pushed;
pushing the target push data to a second client;
causing displaying, on a first client, a first target theme page that is obtained after the target push data is pushed when a first instruction of the first client is received; and
causing displaying a second target theme page corresponding to the first target theme page on the second client after the second client receives the target push data, the first instruction being used for instructing to push the target push data to the second client, the first client logging in to a first account of the social networking application, and the second client logging in to a second account of the social networking application.

2. The method according to claim 1, wherein the obtaining a plurality of pieces of theme data that is to be selected when target push data is pushed comprises:
causing displaying, on the first client, an interactive window used by the first account and the second account to perform a data exchange event;
receiving a second instruction through the interactive window, the second instruction being used for instructing to display a first preset page and requesting, from a server, the plurality of pieces of theme data, the first preset page being used for prompting the first account to set the target push data; and
receiving the plurality of pieces of theme data that is sent by the server according to the second instruction.

3. The method according to claim 2, wherein the selecting, from the plurality of pieces of theme data, target theme data that is used when the target push data is pushed comprises:
displaying a plurality of preset identifiers in one-to-one correspondence with the plurality of pieces of theme data on the first preset page;
receiving a third instruction in a predetermined area of the first preset page, the third instruction being used for instructing to select a target preset identifier from the plurality of preset identifiers, the target preset identifier corresponding to the target theme data; and
determining the target theme data according to the target preset identifier.

4. The method according to claim 2, the method further comprises:
after receiving a second instruction through the interactive window and before selecting, from the plurality of pieces of theme data, target theme data that is used when the target push data is pushed,
causing displaying the first preset page as a page with a default theme.

5. The method according to claim 4, the method further comprises:
after selecting, from the plurality of pieces of theme data, target theme data that is used when the target push data is pushed,
replacing the page with the default theme with a second preset page according to the target theme data, the second preset page matching the target theme data.

6. The method according to claim 1, wherein the pushing the target push data to a second client comprises at least one of:
instructing the second client to display the second target theme page having a correspondence with the first target theme page when the target push data is pushed to the second client, the first target theme page comprising a first color, the second target theme page comprising a second color, and the first target color corresponding to the second target color;
instructing the second client to display the second target theme page having a correspondence with the first target theme page when the target push data is pushed to the second client, the first target theme page comprising a first texture, the second target theme page comprising a second texture, and the first texture corresponding to the second texture; and
instructing the second client to display the second target theme page having a correspondence with the first target theme page when the target push data is pushed to the second client, the first target theme page comprising a first animation element, the second target theme page comprising a second animation element, and the first animation element corresponding to the second animation element.

7. The method according to claim 1, wherein the selecting, from the plurality of pieces of theme data, target theme data that is used when the target push data is pushed comprises:
determining the target theme data corresponding to a preset date in the plurality of pieces of theme data when a current date is the preset date; and/or
determining the target theme data corresponding to a preset condition in the plurality of pieces of theme data when the second account meets the preset condition.

8. The method according to claim 1, the method further comprises:
after pushing the target push data to a second client,
displaying a third theme page corresponding to the second target theme page and displaying the target push data on the third theme page when the second client receives a fourth instruction, the fourth instruction being used for instructing the second client to display the third theme page.

9. The method according to claim 1, the method further comprises:
before pushing the target push data to a second client,
receiving a first setting instruction of the first account through the first client, the first setting instruction being used for instructing to set the target push data; and
obtaining the target push data according to the first setting instruction.

10. The method according to claim 1, the method further comprises:
before pushing the target push data to a second client:
receiving a second setting instruction of the first account through the first client, the second setting instruction being used for instructing to set remark information of the target push data;
wherein the pushing the target push data to a second client comprises: pushing the target push data and the remark information to the second client.

11. A server, comprising one or more processors and one or more memories storing program modules, the program modules, when executed by the one or more processors, cause the server to perform a plurality of operations including:
obtaining a plurality of pieces of theme data that is to be selected when target push data is pushed via a social networking application, the plurality of pieces of theme data being used for displaying different theme pages of the target push data;
selecting, from the plurality of pieces of theme data, target theme data that is used when the target push data is pushed;
pushing the target push data to a second client;
causing displaying, on a first client, a first target theme page that is obtained after the target push data is pushed when a first instruction of the first client is received; and
causing displaying a second target theme page corresponding to the first target theme page on the second client after the second client receives the target push data, the first instruction being used for instructing to push the target push data to the second client, the first client logging in to a first account of the social networking application, and the second client logging in to a second account of the social networking application.

12. The server according to claim 11, wherein the obtaining a plurality of pieces of theme data that is to be selected when target push data is pushed comprises:
causing displaying, on the first client, an interactive window used by the first account and the second account to perform a data exchange event;
receiving a second instruction through the interactive window, the second instruction being used for instructing to display a first preset page and requesting, from a server, the plurality of pieces of theme data, the first preset page being used for prompting the first account to set the target push data; and
receiving the plurality of pieces of theme data that is sent by the server according to the second instruction.

13. The server according to claim 12, wherein the selecting, from the plurality of pieces of theme data, target theme data that is used when the target push data is pushed comprises:
displaying a plurality of preset identifiers in one-to-one correspondence with the plurality of pieces of theme data on the first preset page;
receiving a third instruction in a predetermined area of the first preset page, the third instruction being used for instructing to select a target preset identifier from the plurality of preset identifiers, the target preset identifier corresponding to the target theme data; and
determining the target theme data according to the target preset identifier.

14. The server according to claim 12, wherein the plurality of operations further comprises:
after receiving a second instruction through the interactive window and before selecting, from the plurality of pieces of theme data, target theme data that is used when the target push data is pushed,
causing displaying the first preset page as a page with a default theme.

15. The server according to claim 11, wherein the pushing the target push data to a second client comprises at least one of:
instructing the second client to display the second target theme page having a correspondence with the first target theme page when the target push data is pushed to the second client, the first target theme page comprising a first color, the second target theme page comprising a second color, and the first target color corresponding to the second target color;
instructing the second client to display the second target theme page having a correspondence with the first target theme page when the target push data is pushed to the second client, the first target theme page comprising a first texture, the second target theme page comprising a second texture, and the first texture corresponding to the second texture; and
instructing the second client to display the second target theme page having a correspondence with the first target theme page when the target push data is pushed to the second client, the first target theme page comprising a first animation element, the second target theme page comprising a second animation element, and the first animation element corresponding to the second animation element.

16. The server according to claim 11, wherein the selecting, from the plurality of pieces of theme data, target theme data that is used when the target push data is pushed comprises:
determining the target theme data corresponding to a preset date in the plurality of pieces of theme data when a current date is the preset date; and/or
determining the target theme data corresponding to a preset condition in the plurality of pieces of theme data when the second account meets the preset condition.

17. The server according to claim 11, wherein the plurality of operations further comprises:
after pushing the target push data to a second client,
displaying a third theme page corresponding to the second target theme page and displaying the target push data on the third theme page when the second client receives a fourth instruction, the fourth instruction being used for instructing the second client to display the third theme page.

18. The server according to claim 11, wherein the plurality of operations further comprises:
before pushing the target push data to a second client,
receiving a first setting instruction of the first account through the first client, the first setting instruction being used for instructing to set the target push data; and
obtaining the target push data according to the first setting instruction.

19. The server according to claim 11, wherein the plurality of operations further comprises:
before pushing the target push data to a second client:
receiving a second setting instruction of the first account through the first client, the second setting instruction being used for instructing to set remark information of the target push data;
wherein the pushing the target push data to a second client comprises: pushing the target push data and the remark information to the second client.

20. A non-transitory computer readable storage medium storing a plurality of machine readable instructions in connection with a server having one or more processors, wherein the plurality of machine readable instructions, when executed by the one or more processors, cause the server to perform a plurality of operations including:
obtaining a plurality of pieces of theme data that is to be selected when target push data is pushed via a social networking application, the plurality of pieces of theme data being used for displaying different theme pages of the target push data;
selecting, from the plurality of pieces of theme data, target theme data that is used when the target push data is pushed;
pushing the target push data to a second client;
causing displaying, on a first client, a first target theme page that is obtained after the target push data is pushed when a first instruction of the first client is received; and
causing displaying a second target theme page corresponding to the first target theme page on the second client after the second client receives the target push data, the first instruction being used for instructing to push the target push data to the second client, the first client logging in to a first account of the social networking application, and the second client logging in to a second account of the social networking application.
